(19) United States
(12) Patent Application Publication
(10) Pub. No.: US 2025/0347664 A1
(43) Pub. Date: Nov. 13, 2025

(54) FULL-AUTOMATIC HIGH-THROUGHPUT LC-MS/MS TEST SYSTEM AND METHOD

(71) Applicants: HANGZHOU CALIBRA TECHNOLOGIES CO.LTD, Hangzhou (CN); Calibra Scientific, Inc, Hangzhou (CN)

(72) Inventors: Huafen LIU, Hangzhou (CN); Xiaoping LIU, Hangzhou (CN); Yabo WANG, Hangzhou (CN); Jianbing DU, Hangzhou (CN); Zhibin JI, Hangzhou (CN); Jie XU, Hangzhou (CN)

(21) Appl. No.: 19/184,691

(22) Filed: Apr. 21, 2025

(30) Foreign Application Priority Data
May 11, 2024 (CN) 202410582770.5

(51) Int. Cl. G01N 30/24; G01N 30/72; G01N 35/10; H01J 49/00

(52) U.S. Cl. CPC G01N 30/24; G01N 30/7233; G01N 35/1002; G01N 35/1011; H01J 49/009

(57) ABSTRACT

The vention provide an LC-MS/MS test system, comprising: a full-automatic sample preprocessing module; wherein the full-automatic sample preprocessing module comprises an automatic sample feeding and discharging module for transporting sample baskets to be tested, and the automatic sample feeding and discharging module comprises a routine sample feeding and discharging structure and an emergency sample feeding and discharging structure, wherein the sample baskets to be tested comprise routine sample baskets and an emergency sample basket.

### CROSS-REFERENCE TO RELATED APPLICATIONS

This application claims priority to Chinese Patent Application No. 202410582770.5, filed on May 11, 2024, the claims, abstract, specification and accompanying drawings of which are incorporated by reference in their entirety as a part of this application.

### BACKGROUND OF THE INVENTION

### Field of the Invention

The invention belongs to the technical field of mass spectrometry methods, and in particular to full-automatic liquid chromatography-tandem mass spectrometry based on magnetic extraction and multichannel techniques.

### Description of the Related Art

Liquid chromatography-tandem mass spectrometry (LC-MS/MS) is a direct test method based on the tested biomarker itself. By combining chromatographic separation and triple quadrupole tandem mass spectrometry, this technique performs accurate qualitative and quantitative analysis on the target compound based on the chemical properties, mass and molecular structure of the target compound itself. Therefore, the LC-MS/MS method has the characteristics of high sensitivity, high specificity, wide linear range and wide range of applicable sample types and has significant advantages in the detection of small molecule hormone compounds, and thus, can effectively make up for the deficiencies of immunological methods, such as the difficulty in detecting trace substances and the susceptibility to cross-reaction interference. In recent years, LC-MS/MS has developed rapidly in the field of medical examination, and has great potential in the fields of newborn screening for inherited metabolic diseases, therapeutic drug monitoring, clinical endocrine testing, vitamin and nutrient testing, etc.

However, although many laboratories in medical institutions at home and abroad have introduced LC-MS/MS instruments, they are only used in a few test items, and their large-scale application is still greatly limited. This is mainly because compared with the traditional medical examination technology platforms such as immunology, the work flow of LC-MS/MS is low in automation level and requires a lot of manual procedures, including sample preprocessing, data analysis and collation, report review and release, and method verification, quality control management, and daily problem analysis and solution during the daily method establishment process. Taking the sample preprocessing procedure as an example, this procedure is the most critical and time-consuming step in the whole analysis process, including solution preparation, sample preparation, sample extraction, protein precipitation, centrifugation, concentration and redissolution. For complex samples such as blood samples, which contain various substances unrelated to the target analyte, such as proteins and salt ions, the preprocessing of LC-MS/MS is more complicated, and the processing method is different for different analytes and dependent on the analytes. In addition, the existing clinical LC-MS/MS instruments generally adopt a single-channel sample injection mode, that is, each preprocessed sample sequentially enters the liquid chromatograph and the triple quadrupole mass spectrometer through the automatic sample injector. In order to ensure the specificity of analysis and effectively separate interfering substances with different chemical properties, the liquid chromatography alone often takes 5-10 minutes/sample, which greatly reduces the throughput of LC-MS/MS and brings inconvenience to clinical application. Moreover, all these procedures require technicians with high professional skills and a high level of knowledge in mass spectrometry, and these technicians must undergo strict training. Due to the low automation level, mass spectrometry is much inferior in throughput to immunological methods, and requires a longer test period for individual samples and a higher labor cost. The large number of manual procedures also easily bring in uncertainty, which brings challenges to quality management.

FIG. 1 shows an existing LC-MS/MS solution in the market, and its main defects are as follows. (1) The work flows of LC-MS/MS and preprocessing are low in automation level, and they are usually completed separately, which requires a large number of manual procedures and is time-consuming and laborious. Moreover, the large number of manual procedures also easily bring in uncertainty and are more prone to error. In addition, the apparatuses occupy a large space. (2) The sample preprocessing process is complicated, and the processing method is different for different analytes, causing great differences in processing techniques, higher labor cost and numerous reagents and auxiliary apparatuses to be prepared, thus bringing challenges to quality management. (3) The single-channel sample injection mode is low in efficiency and throughput, and cannot meet the increasing test demand. (4) This solution has high requirements for operators, and requires technicians with high professional skills and a high level of knowledge in mass spectrometry, which limits the popularization of this technique and increases the test cost.

There are many open literatures about LC-MS/MS in the prior art. For example, Chinese patent application No. CN116223664A discloses a dried blood spot extractor-tandem LC-MS/MS test method for 25-hydroxyvitamin D in a dried blood spot. This literature discloses a method for analyzing the content of 25-hydroxyvitamin D in a dried blood spot by a full-automatic dried blood spot extractor-tandem LC-MS/MS analysis system, which does not require complex manual sample processing, has a high automation level of instruments and effectively avoids the influence of human factors. For another example, Chinese patent application No. CN113711030 discloses a method and system for testing 11-oxyandrogens by LC-MS/MS. This system purifies the sample by liquid chromatography, and measures the 11-oxyandrogens by tandem mass spectrometry. For still another example, Chinese patent No. CN104678000B discloses a method for detecting sodium copper chlorophyllin in olive oil by liquid chromatography-tandem mass spectrometry (LC-MS/MS). This patent limits the chromatography and mass spectrometry conditions for qualitative and quantitative detection of sodium copper chlorophyllin by liquid chromatography-tandem mass spectrometry, so that sodium copper chlorophyllin in olive oil can be detected more accurately and reliably and with high sensitivity. The above literatures all mention the detection of a specific substance by LC-MS/MS, and more or less disclose some automatic contents. However, as recorded in the above, all these literatures are mass spectrometry methods and systems dedicated to a certain substance or a certain category of substances, and these methods and systems are not universal, or universal apparatuses cannot realize accurate detection.

### BRIEF SUMMARY OF THE INVENTION

In view of the technical problems in the Description of the Related Art, the invention provides a full-automatic high-throughput LC-MS/MS test method and system based on magnetic extraction and multichannel techniques, which can realize automation and universality of LC-MS/MS.

In order to solve the technical problems above, the invention adopts the following technical solutions:

First, the invention provides a full-automatic high-throughput LC-MS/MS test method based on magnetic extraction and multichannel techniques, which realizes full-automatic testing by using an all-in-one machine including a sample preprocessing module and a multichannel liquid chromatography-mass spectrometry module and specifically includes the following steps:
(1) full-automatic sample preprocessing is performed by magnetic extraction;
(2) the preprocessed sample enters multichannel liquid chromatography apparatuses for separation by automatic sample feeding; and
(3) the sample separated by multichannel liquid chromatography respectively enters a mass spectrometry module through respective channels for analysis.

In some embodiments, sample preprocessing, liquid chromatography and mass spectrometry modules are automatically controlled by a computer, and data obtained by the liquid chromatography and mass spectrometry modules are automatically transmitted to a computer module which generates and outputs a test report.

In some embodiments, in the above method, the magnetic extraction uses a core-shell magnetic mesoporous composite combined with micro domains as an extraction material.

In order to achieve the above test method, the invention further provides a full-automatic high-throughput LC-MS/MS test system based on magnetic extraction and multichannel techniques. The system at least includes a full-automatic sample processing module, a multichannel liquid chromatography-mass spectrometry module and a computer module. The full-automatic sample processing module is configured to perform sample preprocessing by magnetic extraction which uses a core-shell magnetic mesoporous composite combined with micro domains as an extraction material. The multichannel liquid chromatography-mass spectrometry module is configured to perform chromatographic separation by using at least two liquid chromatography channels and then perform testing by a mass spectrometry module, and the computer module generates a report.

Further, the full-automatic sample processing module includes an automatic sample feeding and discharging module, a sample loading module, a reaction module, a reaction vessel loading mechanism, a reaction disk component, a multi-stage cleaning component, a transport module and an eluate input conveyor line. An eluate remaining in reaction vessels to be eluted enters the eluate input conveyor line. The automatic sample feeding and discharging module is configured to complete loading and unloading of sample tubes and also has an emergency sample loading function. The sample loading module is configured to aspirate samples, internal standards and diluents from the automatic sample feeding and discharging module into reaction vessels and configured to perform shaking and mixing and clean a pipette. The reaction module is configured to store an activation liquid, an equilibrium liquid and an eluate and complete addition, shaking and mixing of the activation liquid, the equilibrium liquid and the eluate. The reaction vessel loading mechanism is configured to automatically arrange disorderly empty reaction vessels and load the reaction vessels in order. The reaction disk component is configured to aspirate and transfer a waste liquid into a waste liquid tank through repeated magnetic bead adsorption. The cleaning component is configured to complete washing of magnetic beads and compounds to remove impurities other than the magnetic beads and the analytical compounds, including the activation liquid, the equilibrium liquid and other residual reagents. The transport module is configured to transfer reaction vessels among the modules. The eluate input conveyor line is configured to transfer the cleaned reaction vessels (containing the compounds) to the multichannel liquid chromatography-mass spectrometry module.

Further, the automatic sample feeding and discharging module includes a routine sample feeding module, a sample exit module and a sample feeding and discharging assisting mechanism. The routine sample feeding module is configured to load sample baskets to be tested. The routine sample feeding module serves as a sample entrance channel. The sample baskets to be tested loading large-batch sample tubes are put into this channel, and pushed into a transfer module for sample in and out through the sample feeding and discharging assisting mechanism to enter a sample loading queue. The sample exit module is configured to load tested sample baskets. The sample exit module serves as a sample exit channel. Tested sample tubes exit from the transfer module for sample in and out, and are pushed out by the sample feeding and discharging assisting mechanism and finally transferred into the tested sample baskets. The routine sample feeding module and the sample exit module are respectively located at two sides of the sample feeding and discharging assisting mechanism. The sample feeding and discharging assisting mechanism includes a transmission shaft and a sample shift lever. The sample shift lever is rotatable and movable along the transmission shaft so as to respectively assist in sample feeding and discharging.

The automatic sample feeding and discharging module further includes a sample disk module and a transfer module for sample in and out. The transfer module for sample in and out is located at tail ends of the routine sample feeding module and the sample exit module and is capable of pushing a sample basket to be tested at a tail end into the sample disk module. The sample disk module is located at one side of the sample exit module and provided with a sample basket entrance and exit. Sample basket slots for loading the sample baskets to be tested and the tested sample baskets are arranged in the sample disk module at equal intervals.

The automatic sample feeding and discharging module further includes an emergency sample basket. The emergency sample basket is arranged at one end of the transfer module for sample in and out and configured to be capable of sample loading in priority as a channel for temporary emergency sample application. Temporary small-batch samples are loaded in the emergency sample basket, moved to the front of the sample loading queue and rotated by the sample disk module to a sample loading position for priority processing.

The automatic sample feeding and discharging module further includes a code scanner, and the code scanner is arranged at one side of the transfer module for sample in and out and configured to scan passing sample tubes.

Further, the sample loading module includes a pipetting module, a sample shaking and mixing module and a sample cleaning pool module, and the pipetting module includes a pipette module, a slide rail assembly, a translation sensor module, a translation motor and a cable carrier.

The pipette module includes the pipette, a pipette up-and-down movement motor, a pipette movement timing belt, a pipette zeroing sensor, a pipette zeroing baffle, a pipette slide rail assembly, a pipette pipetting motor, an auxiliary spring, a pipetting action sensor and a pipetting action zeroing baffle. The pipette up-and-down movement motor drives the pipette to move up and down through the pipette movement timing belt, the pipette slide rail assembly guides the pipette to move up and down, the pipette pipetting motor drives the pipetting action zeroing baffle to move up and down, the pipetting action sensor is configured to detect a position of the pipetting action zeroing baffle, and when the pipette zeroing sensor, serving as a limit position sensor, detects the pipette zeroing baffle, it is determined that the pipette is at a zero position in an up-down direction.

The pipetting module further includes a limit baffle and a limit sensor, and when the limit sensor detects the limit baffle, transmission is stopped, and it is determined that the pipette is at a zero position in a left-right direction.

The pipetting module further includes the translation motor, the slide rail assembly and the translation sensor module, the translation motor is configured to drive the pipette module to translate, the slide rail assembly is configured to guide the pipette module to translate, the translation sensor module is arranged at one end of the slide rail assembly and configured to accurately detect a translation position and feed back a signal, and the cable carrier is configured to protect communication and power cables of the pipette module and allow the cables to move together with the pipette module.

The sample shaking and mixing module includes a sample shaking motor, a sample shaking motor coupling, a sample shaking timing belt, a sample shaking driving pulley, a rotational speed sensor, a sensor baffle, reaction vessels, a reaction vessel carrier, a driven shaft coupling, a sample shaking driven pulley and a sample mixing cleaning seat. The sample shaking motor drives the reaction vessel carrier to perform shaking and mixing through the sample shaking motor coupling, the sample shaking timing belt and the sample shaking driving pulley, so that the reaction vessels with the samples are subjected to shaking and mixing.

The sample cleaning pool module stores a pipette cleaning liquid therein. When cleaning is needed, the pipetting module dips the pipette into the pipette cleaning liquid, thereby completing cleaning. A cleaning pool is connected to a “solvent tray station” and a “scrap and waste liquid box” of the “multichannel liquid chromatography-mass spectrometry module” through tubes so as to replenish the cleaning liquid and remove the waste liquid at any time.

Further, the reaction module includes a reaction cleaning pool module, a reaction vessel carrier, a reaction shaker, a reagent aspirating needle lifting motor, a reagent aspirating needle lifting transmission component, a reagent aspirating needle lifting rod support, a reagent aspirating needle rotating motor component, a reagent aspirating needle rotating motor zeroing sensor, a reagent aspirating needle rotating motor position sensor, a reagent aspirating needle component, reagent vessels, a reagent turntable motor and reagent turntable position sensors.

The reaction vessel carrier is arranged in the form of 3*5 (if there are more reagent aspirating needles in the reagent aspirating needle component, the array could be larger). Blank reaction vessels are arranged in the reaction vessel carrier according to certain rules, reagents in the reagent vessels are added to the reaction vessels through the reagent aspirating needles, the reagent aspirating needle lifting motor drives the reagent aspirating needles to rise and fall, the reagent turntable motor drives the reaction vessel carrier to rotate to facilitate reagent selection, and the reagent aspirating needle rotating motor component drives the reagent aspirating needle component to rotate.

The reaction cleaning pool module contains a cleaning agent and is configured to clean the reagent aspirating needles, and after the reagent is added to the reaction vessel, the reaction shaker performs shaking and mixing on the cleaning agent.

Further, the reaction vessel loading mechanism includes a bulk compartment, a roll-on roll-off motor, a roll-on roll-off conveyor belt, a pre-loading channel, a reaction vessel transport tray and a reaction vessel transport tray motor, the roll-on roll-off motor is configured to drive the roll-on roll-off conveyor belt to move, the pre-loading channel is arranged at one side of an upper part of the roll-on roll-off conveyor belt and is in communication with the roll-on roll-off conveyor belt, the bulk compartment is arranged at a starting end of the roll-on roll-off conveyor belt, and the roll-on roll-off conveyor belt is provided with roll-on roll-off partitions; and when the roll-on roll-off conveyor belt is started, disorderly reaction vessels in the bulk compartment enter gaps between the roll-on roll-off partitions one by one so as to orderly enter the pre-loading channel through the roll-on roll-off conveyor belt and then are pushed into the reaction vessel transport tray one by one through the pre-loading channel, and the reaction vessel transport tray rotates the obtained reaction vessels to an outer side such that the reaction vessels are ready to be picked up.

Further, the reaction disk component includes a reaction disk motor, a reaction disk and a reaction disk base, the reaction disk is arranged on the reaction disk base, the reaction disk motor drives the reaction disk to rotate, an outer wall of the reaction disk is provided with a magnetic module, the magnetic module includes at least one group of magnets, each group of magnets includes two magnetic sheets respectively corresponding to a feed port and a discharge port, and the reaction vessels are arranged in the reaction disk at equal intervals.

Further, the multi-stage cleaning component includes a waste liquid aspirating needle, the waste liquid aspirating needle is mounted on a waste liquid aspirating needle moving layer, and the waste liquid aspirating needle moving layer is driven by a waste liquid aspirating needle moving layer movement motor to move up and down such that the waste liquid aspirating needle reaches an aspiration position. The multi-stage cleaning component further includes a liquid adding layer, the liquid adding layer is located below the waste liquid aspirating needle moving layer, the liquid adding layer is provided with a liquid adding needle, the liquid adding layer is driven by a liquid adding layer motor to move up and down, and a reaction vessel claw is arranged below the liquid adding layer. When the liquid adding layer moves down, the reaction vessel claw grips the reaction vessel in a reaction disk component, the liquid adding needle injects a cleaning liquid in air, and then a dropper moving motor drives a reaction vessel dropper to move down such that the reaction vessel is pushed out back into the reaction disk component. The multi-stage cleaning component further includes a guide component (including a guide rod and a nut) for guiding the liquid adding layer and the waste liquid aspirating needle moving layer to move up and down.

An outside of the waste liquid aspirating needle is coated with Teflon, such that there is no residue on an outer wall after the waste liquid is sucked out.

Empty reaction vessels are picked up from the reaction vessel transport tray of a reaction vessel loading mechanism to the reaction vessel carrier of the reaction module.

The reaction vessels are transferred from the reaction vessel carrier of the reaction module to the reaction disk component.

The reaction vessels are transferred from the reaction disk component into the sample shaking and mixing module of the sample loading module.

The reaction vessels are transferred from the sample shaking and mixing module of the sample loading module into the reaction disk component.

The reaction vessels are transferred from the reaction disk component into an eluate input conveyor line.

Further, the transport module includes a mounting base, a first-level manipulator arm, a second-level manipulator arm, a third-level manipulator arm, a fourth-level manipulator arm, a fifth-level manipulator arm, a sixth-level manipulator arm and a vessel pickup Z-direction gripper component, and the manipulator arms of all levels are rotatable relative to each other to realize multi-angle multi-range rotation; the vessel pickup Z-direction gripper component includes a Z-axis motion motor, a Z-axis timing belt and a motion connector, the Z-axis motion motor drives the gripper component to move up and down through the Z-axis timing belt and the motion connector, the vessel pickup Z-direction gripper component further includes vessel pickup gripper jaws arranged in pair, the vessel pickup gripper jaws arranged in pair are respectively mounted on the vessel pickup slide rail component oppositely and connected through a vessel pickup spring, a vessel pickup curved wheel is arranged between upper ends of the two vessel pickup gripper jaws, and the vessel pickup curved wheel is rotatable when driven by a vessel pickup motor; when a wider part of the vessel pickup curved wheel rotates to between the upper ends of the vessel pickup gripper jaws, the vessel pickup gripper jaws are pushed open along the vessel pickup slide rail component, at this time, the vessel pickup gripper jaws are sleevable on an upper part of the reaction vessel, and then, the vessel pickup curved wheel continues rotating until a narrow part rotates to between the upper ends of the vessel pickup gripper jaws, thereby completing pickup; auxiliary structures include a Z-axis motion slide rail component and an auxiliary spring, where the Z-axis motion slide rail component serves as a guide component for up-and-down sliding, and the auxiliary spring functions to support a weight and reduce a motor load; and in addition, a vessel pickup limit sensor and a vessel pickup limit sensor chip are further provided to improve accuracy of vessel pickup.

Further, the eluate (reaction vessels to be eluted) input conveyor line includes an output conveyor motor, an output timing pulley, an output timing belt, a reaction vessel conveyor support and an elution output line seat, the reaction vessel conveyor support is arranged above the output timing belt and is capable of limiting the reaction vessels on the output timing belt, and the output conveyor motor drives the output timing belt to move through the output timing pulley so as to transfer the reaction vessels on the reaction vessel conveyor support to a next station (multichannel injection module).

Further, the multichannel liquid chromatography-mass spectrometry module includes a frame, and a triple quadrupole mass spectrometry module, a multichannel injection and separation module, a film sealing module, a constant-temperature storage chamber, a waste collection chamber, a waste liquid barrel, a mechanical vacuum pump and nitrogen generator module and a sample assembly line are arranged in the frame.

The triple quadrupole mass spectrometry module is configured to complete data acquisition and establish communication with the computer module. The multichannel injection and separation module completes double-channel cooperative injection. The film sealing module completes film sealing of the reaction vessels after injection. The constant-temperature storage chamber is configured to store the reaction vessels that have completed film sealing, so that the reaction vessels can be taken out for re-injection when abnormalities occur. The waste collection chamber is configured to store the waste liquid, waste reaction vessels and other wastes. In the mechanical vacuum pump and nitrogen generator module, a mechanical vacuum pump is a backing pump of the triple quadrupole mass spectrometry module and cooperates with the triple quadrupole mass spectrometry module to complete vacuum suction together. The sample assembly line is configured to place the cleaned reaction vessels from the full-automatic sample processing module and transmit the cleaned reaction vessels to docking positions of the multichannel injection and separation module, the film sealing module and the constant-temperature storage chamber.

Further, the multichannel injection and separation module includes a reagent bottle placement area. A solvent proportioning valve, a degasser module, a primary liquid-phase pump, a secondary liquid-phase pump and a mixer are sequentially arranged outside the reagent bottle placement area along a flow direction of the reagents. A lower part of the multichannel injection and separation module is provided with an injection assembly. The injection assembly aspirates a liquid sample from an injection sample reaction vessel. The multichannel injection and separation module further includes a column switching and separation module. The solvent proportioning valve is configured to adjust a proportion of solvents. The degasser module is configured to remove bubbles in reagent tubes. The primary liquid-phase pump and the secondary liquid-phase pump are configured to drive the reagents to flow. The mixer is configured to mix reagents of different mobile phases. The injection assembly includes at least two injection modules. Each injection module independently implements magnetic bead separation by nitrogen blowing, syringe sample aspiration and cleaning. The multichannel injection and separation module further includes injection valves. The injection valves are connected to the mixer, the syringe of the injection assembly, and the separation module. The separation module includes a preheating module, a temperature field adjusting module and a channel switching module. (The specific structure of the injection valves is recorded in the specification)

Further, the injection assembly includes a syringe kit, a first channel reaction vessel, a reaction vessel fixing seat, a sample processing table and a second channel reaction vessel. The syringe kit includes a fixed seat, a Z-axis gear, a Z-axis timing pulley, an X-axis lead screw, an X-axis timing pulley, a Z-axis driving timing belt, an X-axis driving timing belt, a Z-axis transmission gear, a Z-axis connecting slider, a Z-axis slide rail component, a nitrogen blower, an injection tube, a spring, a reaction vessel pressing tube, a syringe holder and a pipette. The Z-axis timing pulley drives the Z-axis gear to rotate, and the rotation is transmitted to the Z-axis connecting slider through the Z-axis transmission gear such that the Z-axis connecting slider moves up and down. The Z-axis connecting slider is fixed on the Z-axis slide rail component. The X-axis driving timing belt drives the X-axis timing pulley and the X-axis lead screw to rotate, so that the syringe holder moves left and right along the X-axis. The nitrogen blower is connected to a nitrogen source. The nitrogen blower is pressed against the reaction vessel, the nitrogen source is opened to realize a positive pressure, and a filter assembly is used in combination to complete filtration of the magnetic beads. Each channel is matched with 1 syringe kit to complete filtration of the magnetic beads and aspiration of the sample. When the solvent needs to be aspirated, the reaction vessel pressing tube is pressed against the reaction vessel or the sample processing table, the spring is compressed by force, the pipette inside extends out, aspirates the solvent and moves up upon completion, the spring returns to its original state, and the injection tube is connected to Port 4 of the six-way valve.

The injection sample reaction vessel includes a magnetic bead filter module and a reaction vessel. The magnetic bead filter module is arranged on the reaction vessel. The magnetic bead filter module includes a filter seat and a filter layer. The filter seat contains filter holes therein.

Further, the column switching and separation module includes an external radiator, an internal radiator, an internal fan, a temperature sensor, chromatographic column clamps, a preheating module and a column switching valve. The chromatographic column clamps are configured to fix double-channel chromatographic columns. The chromatographic column is selected according to the type of the compound. An output tube from Port 6 of the six-way valve passes through radiating fins of the preheating module before entering the chromatographic column. A thermoelectric cooler is mounted between the external radiator and the internal radiator to realize temperature control. The internal fan improves the control efficiency. The temperature sensor is configured to detect a temperature. The column switching valve is connected to both of the two chromatographic columns to realize time-sharing injection.

Further, the film sealing module includes a film covering motor, a lifting motor, a lifting slider, a rotating motor, a film covering module, a film kit, a film and guide wheels. The film covering motor drives the film kit and the film to roll under the guide of the guide wheels. The lifting motor and the lifting slider drive the rotating motor and a film covering head to move up and down, so that the film covering head can contact the reaction vessel that has completed sampling. The film covering module includes the film covering head and an outer cover. The film covering head includes a pressing plate, a pressing plate spring, a bearing, a jack screw, side pressing springs and side pressing steel balls. When the film covering module moves down, the pressing plate is configured to fix the reaction vessel, the pressing plate spring is compressed and pressed against an upper surface of the reaction vessel through the covering film, the reaction vessel extends deep inside, the side pressing springs also retract, the side pressing steel balls press against the covering film on the side of the reaction vessel, the rotating motor rotates a number of turns, and the side of the reaction vessel is sealed.

Based on the above system, the invention may further provide a multichannel injection method for full-automatic high-throughput LC-MS/MS testing. The injection method adopts the above full-automatic high-throughput LC-MS/MS test system and includes the following steps:
1) the syringe is cleaned with a strong cleaning liquid and a weak cleaning liquid (the cleaning liquids are selected according to the type of the sample and the type of the compound, and conventionally, the mobile phase A is an aqueous phase-containing solution and the mobile phase B is an organic phase solution);
2) the syringe aspirates a first sample (the amount of the sample aspirated is 1-100 μL) and injects the first sample into the switching valve of one channel;
3) the switching valve is switched to an injection position, and injection is started (the flow rate is 0.2-1.5 mL/min);
the sample is sequentially connected to the chromatographic column (the chromatographic column is in a column oven module, and the column oven temperature is 5-85° C.);
4) the chromatographic column switching valve is switched to mass spectrometry, and the sample is collected;
5) the syringe is cleaned with the strong cleaning liquid and the weak cleaning liquid;
6) the syringe aspirates a second sample (the amount of the sample aspirated is 1-100 μL) and injects the second sample into the switching valve of the other channel; and
7) the switching valve of the other channel is switched to an injection position, and injection is started. At this time, the injection and collection of the first sample have not been completed, the sample of the other channel in this step is connected to the other chromatographic column, this chromatographic column is connected to another inlet port of the chromatographic column switching valve and in communication with a waste liquid output port, and after peak appearance of the first sample is completed, the injection of the second sample is immediately started.

In some embodiments, the invention provides the following technical solution as a part of the invention.

An LC-MS/MS test system includes a full-automatic sample preprocessing module. The full-automatic sample preprocessing module includes an automatic sample feeding and discharging module, and the automatic sample feeding and discharging module includes a routine sample feeding and discharging structure and an emergency sample feeding and discharging structure. In some embodiments, the automatic sample feeding and discharging module further includes a transfer module for sample in and out. The transfer module for sample in and out is located at tail ends of a routine sample feeding module and a sample exit module and is capable of pushing a sample basket to be tested at a tail end into a sample disk module, the sample disk module is located at one side of the sample exit module and provided with a sample basket entrance and exit, and sample basket slots for loading the sample baskets to be tested and tested sample baskets are arranged in the sample disk module at equal intervals. In some embodiments, the automatic sample feeding and discharging module further includes an emergency sample basket. The emergency sample basket is arranged at one end of the transfer module for sample in and out and configured to be capable of sample loading in priority as a channel for temporary emergency sample application. Temporary small-batch samples are loaded in the emergency sample basket, moved to the front of the sample loading queue and rotated by the sample disk module to a sample loading position for priority processing.

In some embodiments, the full-automatic sample preprocessing module further includes a sample loading module, the sample loading module includes a pipetting module, a sample shaking and mixing module and a sample cleaning pool module for cleaning a pipette, and the pipetting module includes a pipette module, a slide rail assembly, a translation sensor module, a translation motor and a cable carrier. In some embodiments, the pipette module includes the pipette, a pipette up-and-down movement motor, a pipette movement timing belt, a pipette zeroing sensor, a pipette zeroing baffle, a pipette slide rail assembly, a pipette pipetting motor, an auxiliary spring, a pipetting action sensor and a pipetting action zeroing baffle; and the pipette up-and-down movement motor drives the pipette to move up and down through the pipette movement timing belt, the pipette slide rail assembly guides the pipette to move up and down, the pipette pipetting motor drives the pipetting action zeroing baffle to move up and down, the pipetting action sensor is configured to detect a position of the pipetting action zeroing baffle, and when the pipette zeroing sensor, serving as a limit position sensor, detects the pipette zeroing baffle, it is determined that the pipette is at a zero position in an up-down direction. In some embodiments, the pipetting module further includes a limit baffle and a limit sensor, and when the limit sensor detects the limit baffle, transmission is stopped, and it is determined that the pipette is at a zero position in a left-right direction. In some embodiments, the pipetting module further includes the translation motor, the slide rail assembly and the translation sensor module, the translation motor is configured to drive the pipette module to translate, the slide rail assembly is configured to guide the pipette module to translate, the translation sensor module is arranged at one end of the slide rail assembly and configured to accurately detect a translation position and feed back a signal, and the cable carrier is configured to protect communication and power cables of the pipette module and allow the cables to move together with the pipette module. In some embodiments, the sample shaking and mixing module includes a sample shaking motor, a sample shaking motor coupling, a sample shaking timing belt, a sample shaking driving pulley, a rotational speed sensor, a sensor baffle, reaction vessels, a reaction vessel carrier, a driven shaft coupling, a sample shaking driven pulley and a sample mixing cleaning seat. The sample shaking motor drives the reaction vessel carrier to perform shaking and mixing through the sample shaking motor coupling, the sample shaking timing belt and the sample shaking driving pulley, so that the reaction vessels with the samples are subjected to shaking and mixing.

In some embodiments, the full-automatic sample processing module further includes a reaction module, and the reaction module includes a reaction cleaning pool module, a reaction vessel carrier, a reaction shaker, a reagent aspirating needle lifting motor, a reagent aspirating needle lifting transmission component, a reagent aspirating needle lifting rod support, a reagent aspirating needle rotating motor component, a reagent aspirating needle rotating motor zeroing sensor, a reagent aspirating needle rotating motor position sensor, a reagent aspirating needle component, reagent vessels, a reagent turntable motor and reagent turntable position sensors. In some embodiments, the reaction vessel carrier has sockets, blank reaction vessels are arranged in the sockets of the reaction vessel carrier according to certain rules, reagents in the reagent vessels are added to the reaction vessels through the reagent aspirating needles, the reagent aspirating needle lifting motor drives the reagent aspirating needles to rise and fall, the reagent turntable motor drives the reaction vessel carrier to rotate to facilitate reagent selection, and the reagent aspirating needle rotating motor component drives the reagent aspirating needle component to rotate. In some embodiments, the reaction cleaning pool module contains a cleaning agent and is configured to clean the reagent aspirating needles, and after the reagent is added to the reaction vessel, the reaction shaker performs shaking and mixing on the cleaning agent.

In some embodiments, the full-automatic sample processing module further includes a reaction vessel loading mechanism, the reaction vessel loading mechanism includes a bulk compartment, a roll-on roll-off motor, a roll-on roll-off conveyor belt, a pre-loading channel, a reaction vessel transport tray and a reaction vessel transport tray motor, the roll-on roll-off motor is configured to drive the roll-on roll-off conveyor belt to move, the pre-loading channel is arranged at one side of an upper part of the roll-on roll-off conveyor belt and is in communication with the roll-on roll-off conveyor belt, the bulk compartment is arranged at a starting end of the roll-on roll-off conveyor belt, and the roll-on roll-off conveyor belt is provided with roll-on roll-off partitions; and when the roll-on roll-off conveyor belt is started, disorderly reaction vessels in the bulk compartment enter gaps between the roll-on roll-off partitions one by one so as to orderly enter the pre-loading channel through the roll-on roll-off conveyor belt and then are pushed into the reaction vessel transport tray one by one through the pre-loading channel, and the reaction vessel transport tray rotates the obtained reaction vessels to an outer side such that the reaction vessels are ready to be picked up.

In some embodiments, the full-automatic sample processing module further includes a magnetic processing module, the magnetic processing module includes a magnetic reaction disk motor, a magnetic reaction disk and a reaction disk base, the magnetic reaction disk is arranged on the reaction disk base, the magnetic reaction disk motor drives the magnetic reaction disk to rotate, an outer wall of the magnetic reaction disk is provided with a magnetic module, the magnetic module includes at least one group of magnets, each group of magnets includes two magnetic sheets respectively corresponding to a feed port and a discharge port, and the reaction vessels are arranged in the reaction disk at equal intervals. In some embodiments, the full-automatic sample processing module further includes a multi-stage cleaning component, and the multi-stage cleaning component is arranged on the magnetic reaction disk in the magnetic processing module. In some embodiments, the multi-stage cleaning component includes a waste liquid aspirating needle, the waste liquid aspirating needle is mounted on a waste liquid aspirating needle moving layer, and the waste liquid aspirating needle moving layer is driven by a waste liquid aspirating needle moving layer movement motor to move up and down such that the waste liquid aspirating needle reaches an aspiration position. The multi-stage cleaning component further includes a liquid adding layer, the liquid adding layer is located below the waste liquid aspirating needle moving layer, the liquid adding layer is provided with a liquid adding needle, the liquid adding layer is driven by a liquid adding layer motor to move up and down, and a reaction vessel claw is arranged below the liquid adding layer. When the liquid adding layer moves down, the reaction vessel claw grips the reaction vessel in a reaction disk component, the liquid adding needle injects a cleaning liquid in air, and then a dropper moving motor drives a reaction vessel dropper to move down such that the reaction vessel is pushed out back into the reaction disk component. The multi-stage cleaning component further includes a guide component for guiding the liquid adding layer and the waste liquid aspirating needle moving layer to move up and down.

In some embodiments, the full-automatic sample processing module further includes a reaction vessel transmission and transport module including a manipulator, and the manipulator realizes transmission of the reaction vessels.

In some embodiments, a shaking disk in a sample application module, a shaking table of the reaction module and the reaction vessel transport tray of the reaction vessel loading mechanism are located at a same side of the manipulator, and the magnetic processing module is located at an upper side of the manipulator.

In some embodiments, the manipulator includes a mounting base, a first-level manipulator arm, a second-level manipulator arm, a third-level manipulator arm, a fourth-level manipulator arm, a fifth-level manipulator arm, a sixth-level manipulator arm and a vessel pickup Z-direction gripper component, and the manipulator arms of all levels are rotatable relative to each other to realize multi-angle multi-range rotation; the vessel pickup Z-direction gripper component includes a Z-axis motion motor, a Z-axis timing belt and a motion connector, the Z-axis motion motor drives the gripper component to move up and down through the Z-axis timing belt and the motion connector, the vessel pickup Z-direction gripper component further includes vessel pickup gripper jaws arranged in pair, the vessel pickup gripper jaws arranged in pair are respectively mounted on the vessel pickup slide rail component oppositely and connected through a vessel pickup spring, a vessel pickup curved wheel is arranged between upper ends of the two vessel pickup gripper jaws, and the vessel pickup curved wheel is rotatable when driven by a vessel pickup motor; when a wider part of the vessel pickup curved wheel rotates to between the upper ends of the vessel pickup gripper jaws, the vessel pickup gripper jaws are pushed open along the vessel pickup slide rail component, at this time, the vessel pickup gripper jaws are sleevable on an upper part of the reaction vessel, and then, the vessel pickup curved wheel continues rotating until a narrow part rotates to between the upper ends of the vessel pickup gripper jaws, thereby completing pickup; auxiliary structures include a Z-axis motion slide rail component and an auxiliary spring, where the Z-axis motion slide rail component serves as a guide component for up-and-down sliding, and the auxiliary spring functions to support a weight and reduce a motor load; and in addition, a vessel pickup limit sensor and a vessel pickup limit sensor chip are further provided to improve accuracy of vessel pickup.

In some embodiments, the system further includes an eluate input conveyor line, and the conveyor line connects the full-automatic sample processing module with a liquid chromatography apparatus and is configured to transmit a magnetic eluate from the sample processing module to the liquid chromatography apparatus.

In some embodiments, the sample baskets carry sample tubes therein, and the sample tubes are configured to contain liquid samples.

The invention has the following beneficial effects: (1) The invention can realize full-automatic integrated testing. The all-in-one machine can operate automatically from sample entry to report generation, with unattended operation and high speed, which greatly lowers the quantity of labor and the technical threshold for personnel and reduces the personnel cost. (2) By using a magnetic nano material extraction technique, the invention can cover a wider range of sample types and has high universality. Moreover, the invention is healthier, more environmentally-friendly and more user-friendly. Compared with the traditional protein precipitation method, the invention does not need a large centrifuging device, and thus is smaller in size and more energy-saving. (3) The sample loading procedure has a routine loading mode and an emergency loading mode, which is close to the clinical needs. (4) By using the multichannel technique, the invention greatly improves the utilization rate of liquid chromatography-mass spectrometry, enhances the test efficiency on the premise of increasing the test throughput and meeting the clinical test needs, and reduces the test cost and equipment depreciation cost. (5) The test method of the invention realizes automatic proportioning of mobile phases and standard curve solutions, thereby reducing the manual operation procedures, enhancing the efficiency, reducing the frequency of personnel contacting reagents and being more friendly.

### BRIEF DESCRIPTION OF THE DRAWINGS

FIG. 1 is a schematic diagram showing an LC-MS/MS solution in the prior art in Description of the Related Art according to the invention;

FIG. 2A is a frame diagram showing the overall design of the invention;

FIG. 2B is an automatic flowchart of part of operations of sample preprocessing;

FIG. 2C is a flowchart showing automatic processing after sample elution and before liquid chromatography testing;

FIG. 2D is a flowchart of automatic sample preprocessing, processing before liquid chromatography testing and liquid chromatography testing, and mass spectrometry testing;

FIG. 3 is a schematic structural view showing the layout of a full-automatic sample processing module according to the invention (from sample to eluate);

FIG. 4 is a schematic structural view of an automatic sample feeding and discharging module according to the invention;

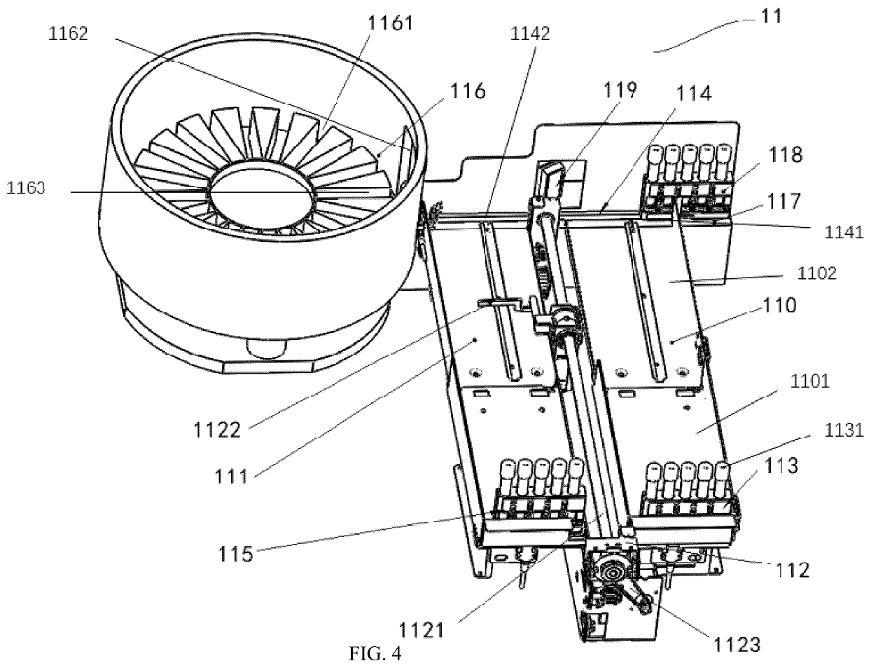

FIG. 5 is a schematic structural view of a sample loading module according to the invention;

FIG. 6 is a schematic view of a pipetting module according to the invention;

FIG. 7 is a schematic view of a pipette module according to the invention;

FIG. 8 is a partial enlarged view of the pipette module according to the invention;

FIG. 9 is a schematic view of a sample shaking and mixing module according to the invention;

FIG. 10A is a schematic view of a reaction module according to the invention;

FIG. 10B is a schematic three-dimensional structural view of a reagent needle liquid adding structure;

FIG. 11 is a schematic view of a reaction vessel loading mechanism according to the invention;

FIG. 12 is a schematic view of a reaction disk component according to the invention;

FIG. 13A is a schematic view of a multi-stage cleaning component according to the invention;

FIG. 13B is a schematic view showing a positional relationship between a magnetic reaction disk and the multi-stage cleaning component;

FIG. 14A is a schematic view of a transport module according to the invention;

FIG. 14B is a schematic view showing an internal rotating structure of manipulator arms;

FIG. 15A is a schematic view of a vessel pickup Z-direction gripper component according to the invention;

FIG. 15B is a schematic view of the vessel pickup Z-direction gripper component according to the invention;

FIG. 15C is a schematic view of the vessel pickup Z-direction gripper component according to the invention;

FIG. 15D is a schematic three-dimensional structural view of a rotating member in the vessel pickup Z-direction gripper component according to the invention;

FIG. 16 is a schematic view of an eluate input conveyor line according to the invention;

FIG. 17 is a schematic view of a multichannel liquid chromatography-mass spectrometry module according to the invention;

FIG. 18 is a schematic view of a multichannel injection and separation module according to the invention;

FIG. 19 is a schematic view showing an injection mode of a six-way injection valve according to the invention;

FIG. 20 is a schematic view showing an equilibrium mode of the six-way injection valve according to the invention;

FIG. 21 is a schematic view of an injection assembly according to the invention;

FIG. 22 is a schematic view of a syringe kit according to the invention;

FIG. 23 is a partial structural sectional view of the syringe kit according to the invention;

FIG. 24 is a schematic view of an injection sample reaction vessel according to the invention;

FIG. 25 is a sectional view of a magnetic bead filter module according to the invention;

FIG. 26 is a schematic view of the magnetic bead filter module according to the invention;

FIG. 27 is a schematic view of a column switching and separation module according to the invention;

FIG. 28 is a structural view of a film sealing module according to the invention;

FIG. 29 is a schematic view of a film covering module according to the invention;

FIG. 30 is an internal structural view of the film covering head according to the invention; and

FIG. 31 is an overall structural view of the invention.

Reference signs in the figures: full-automatic sample processing module 1, automatic sample feeding and discharging module 11, routine sample feeding module 110, sample exit module 111, sample feeding and discharging assisting mechanism 112, sample feeding and discharging assisting transmission shaft 1121, sample shift lever 1122, handle 1123, sample basket to be tested 113, transfer module for sample in and out 114, tested sample basket 115, sample disk module 116, sample basket slot 1161, transfer slide rail for sample in and out 117, emergency sample basket 118, code scanner 119, sample loading module 12, pipetting module 121, pipette module 1211, pipette 12111, pipette up-and-down movement motor 12112, pipette movement timing belt 12113, pipette zeroing sensor 12114, pipette zeroing baffle 12115, pipette slide rail assembly 12116, pipette pipetting motor 12117, pipette auxiliary spring 12118, pipetting action sensor 12119, pipetting action zeroing baffle 121110, pipetting limit baffle 1212, pipetting limit sensor 1213, pipetting translation motor 1214, pipetting slide rail assembly 1215, pipetting translation sensor module 1216, cable carrier 1217, sample shaking and mixing module 122, sample shaking motor 1221, sample shaking motor coupling 1222, sample shaking timing belt 1223, sample shaking driving pulley 1224, rotational speed sensor 1225, reaction vessel 1226, reaction vessel carrier 1227, driven shaft coupling 1228, sample shaking driven pulley 1229, sample mixing cleaning seat 12210, sample cleaning pool module 123, reaction module 13, reaction cleaning pool module 130, reaction vessel carrier 131, reaction shaker 132, reagent aspirating needle lifting motor 133, reagent aspirating needle lifting transmission component 134, reagent aspirating needle lifting rod support 135, reagent aspirating needle rotating motor component 136, reagent aspirating needle component 137, reagent vessel 138, reagent turntable motor 139, reaction vessel loading mechanism 14, bulk compartment 140, roll-on roll-off motor 141, roll-on roll-off conveyor belt 142, pre-loading channel 143, reaction vessel transport tray 144, reaction vessel transport tray motor 145, roll-on roll-off partition 146, reaction disk component 15, reaction disk motor 150, reaction disk 151, reaction disk base 152, magnetic module 153, magnetic sheet 154, multi-stage cleaning component 16, waste liquid aspirating needle 160, waste liquid aspirating needle moving layer 161, waste liquid aspirating needle moving layer movement motor 162, liquid adding layer 163, liquid adding needle 164, liquid adding layer motor 165, reaction vessel claw 166, dropper moving motor 167, reaction vessel dropper 168, guide component 169, transport module 17, mounting base 170, first-level manipulator arm 171, second-level manipulator arm 172, third-level manipulator arm 173, fourth-level manipulator arm 174, fifth-level manipulator arm 175, sixth-level manipulator arm 176, vessel pickup Z-direction gripper component 177, Z-axis motion motor 1771, Z-axis timing belt 1772, motion connector 1773, vessel pickup gripper jaw 1774, vessel pickup curved wheel 1775, vessel pickup motor 1776, Z-axis motion slide rail component 1777, auxiliary spring 1778, vessel pickup slide rail component 178, vessel pickup spring 179, eluate input conveyor line 18, output conveyor motor 180, output timing pulley 181, output timing belt 182, reaction vessel conveyor support 183, elution output line seat 184, multichannel liquid chromatography-mass spectrometry module 2, frame 21, triple quadrupole mass spectrometry module 22, multichannel injection and separation module 23, reagent bottle placement area 230, reagent bottle 2301, solvent proportioning valve 231, degasser module 232, primary liquid-phase pump 233, secondary liquid-phase pump 234, mixer 235, injection assembly 236, injection module 2360, syringe kit 2361, first channel reaction vessel 2362, reaction vessel fixing seat 2363, sample processing table 2364, second channel reaction vessel 2365, fixed seat 23610, Z-axis gear 23611, Z-axis timing pulley 23612, X-axis lead screw 23613, X-axis timing pulley 23614, Z-axis driving timing belt 23615, X-axis driving timing belt 23616, Z-axis transmission gear 23617, Z-axis connecting slider 23618, Z-axis slide rail component 23619, nitrogen blower 23620, injection tube 23621, spring 23622, reaction vessel pressing tube 23623, syringe holder 23624, pipette 23625, injection sample reaction vessel 237, magnetic bead filter module 2370, reaction vessel 2371, filter seat 2372, filter layer 2373, filter hole 2374, column switching and separation module 238, external radiator 2381, internal radiator 2382, internal fan 2383, temperature sensor 2384, chromatographic column clamp 2385, preheating module 2386, column switching valve 2387, six-way injection valve 239, film sealing module 24, film covering motor 240, lifting motor 241, lifting slider 242, rotating motor 243, film covering module 244, film kit 245, film 246, guide wheel 247, film covering head 2441, outer cover 2442, pressing plate 24411, pressing plate spring 24412, bearing 24413, jack screw 24414, side pressing spring 24415, side pressing steel ball 24416, constant-temperature storage chamber 25, waste collection chamber 26, waste liquid barrel 27, mechanical vacuum pump and nitrogen generator module 28, sample assembly line 29, observation window 210, computer module 3.

### DETAILED DESCRIPTION OF THE INVENTION

In order to make those skilled in the art better implement the technical solutions of the invention, the specific implementation process of the invention will be described in detail by means of specific embodiments with reference to the accompanying drawings. It should be noted that the embodiments should not be regarded as a limitation of the invention, and the scope of protection of the invention shall be based on the contents embodied in the claims.

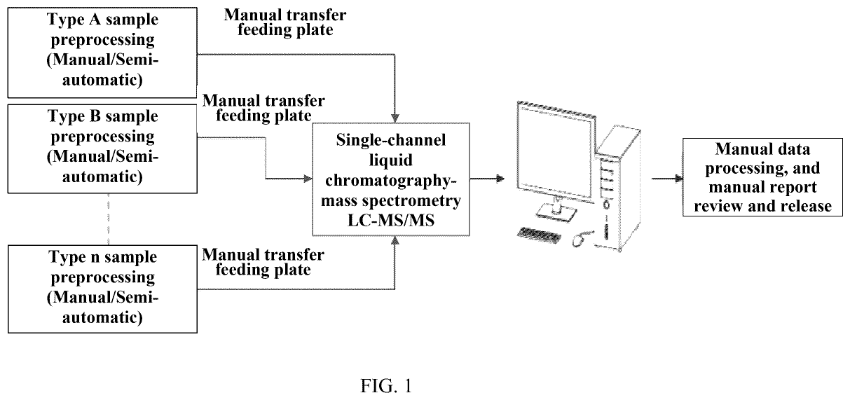

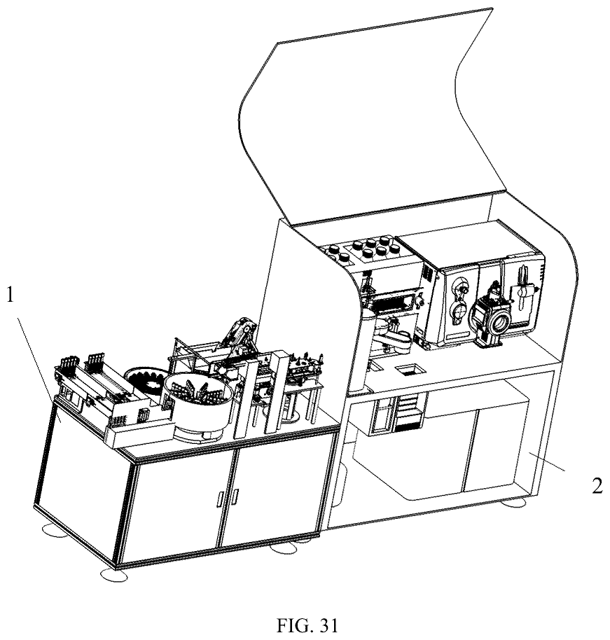

### Embodiment 1: Refer to FIG. 1 and FIG. 31.

As shown in the figures, this embodiment provides a full-automatic high-throughput LC-MS/MS test system based on magnetic extraction and multichannel techniques. The system includes a full-automatic sample processing module 1 and a multichannel liquid chromatography-mass spectrometry module 2. The full-automatic sample processing module 1 delivers a sample subjected to magnetic extraction into the multichannel liquid chromatography-mass spectrometry module 2 by means of automatic sample feeding. The multichannel liquid chromatography-mass spectrometry module includes a plurality of channel liquid chromatography apparatuses, such as channel-A liquid chromatography, channel-B liquid chromatography, . . . , channel-n liquid chromatography. The sample, after respectively passing through liquid chromatography apparatuses of different channels, enters the mass spectrometry module for testing. Besides, the full-automatic sample processing module 1 and the multichannel liquid chromatography-mass spectrometry module are both connected to a computer and software module 3, and transmit data to the computer and software module. The computer and software module generates a test report according to the received data. Actually, after the sample is processed, one sample can be divided into several parts, each part enters one liquid chromatography apparatus for liquid chromatography, and the sample subjected to liquid chromatography enters the mass spectrometry module for mass spectrometry. If there are a plurality of liquid chromatography apparatuses, then a plurality of analytes can be analyzed, or different liquid chromatography analyses can be performed according to different processing requirements, and the sample subjected to liquid chromatography enters the mass spectrometry module. In this way, one sample can be tested for multiple analytes. Moreover, the whole process is automated and requires no human involvement.

### Embodiment 2: Refer to FIG. 1.

This embodiment provides a full-automatic high-throughput LC-MS/MS test method based on magnetic extraction and multichannel techniques, which uses the system of Embodiment 1 and realizes full-automatic testing by using an all-in-one machine including a sample preprocessing module and a multichannel liquid chromatography-mass spectrometry module. The method specifically includes the following steps:
S1: Full-automatic sample preprocessing is performed by magnetic extraction. The magnetic extraction uses a core-shell magnetic mesoporous composite combined with micro domains as an extraction material.
S2: The preprocessed sample enters multichannel liquid chromatography apparatuses for separation by automatic sample feeding.
S3: The sample separated by multichannel liquid chromatography respectively enters a mass spectrometry module through respective channels for analysis.

The sample preprocessing, liquid chromatography and mass spectrometry modules respectively transmit data to the computer module, which generates and outputs the test report.

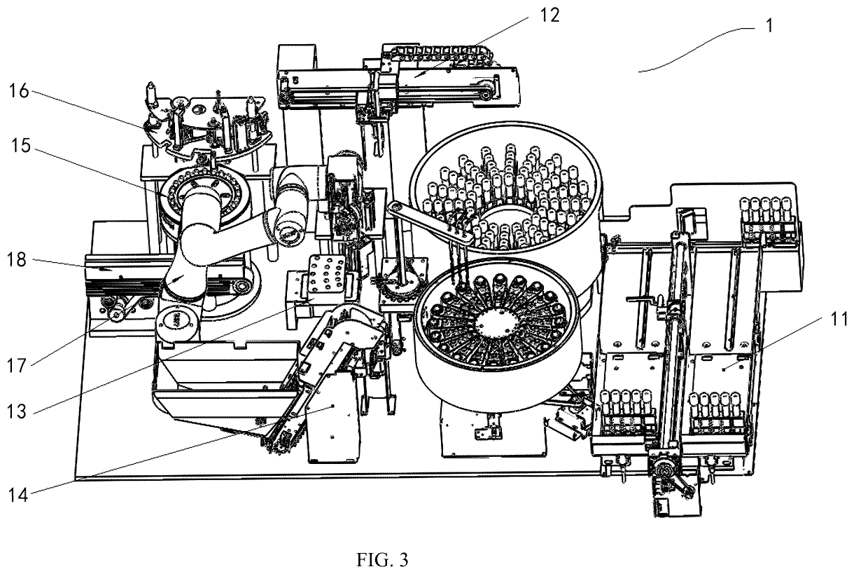

This embodiment provides a full-automatic sample processing module 1 applicable to Embodiment 1 and/or Embodiment 2. As shown in FIG. 3, the full-automatic sample processing or sample processing system includes an automatic sample feeding and discharging module or mechanism 11, a sample loading module 12, a reaction module 13, a reaction vessel loading mechanism 14, a reaction disk component 15, a multi-stage cleaning component 16, a transport module 17 and an eluate input conveyor line 18. In some embodiments, in the eluate input conveyor line 18, an eluate remaining in reaction vessels to be eluted enters the eluate input conveyor line. The “module” here also means unit or mechanism, and it can also mean structure. These mechanisms or structures with different functions cooperate with each other to form the whole sample processing system for automatic sample processing. The cooperation of these structures realizes the automatic loading and unloading of samples.

The full-automatic sample processing module includes the automatic sample feeding and discharging module 11, the sample loading module 12, the reaction module 13, the reaction vessel loading mechanism 14, the reaction disk component 15, the multi-stage cleaning component 16, the transport module 17 and the eluate (reaction vessels to be eluted) input conveyor line 18, as shown in FIG. 3. The automatic sample feeding and discharging module 11 has a function of completing loading and unloading of sample tubes and also has an emergency sample loading function. The sample loading module 12 has functions of aspirating samples, internal standards and diluents from the “automatic sample feeding and discharging module 11” into reaction vessels, performing shaking and mixing and cleaning aspirating needles. The reaction module 13 has functions of storing an activation liquid, an equilibrium liquid and an eluate and completing addition, shaking and mixing of the activation liquid, the equilibrium liquid and the eluate. The reaction vessel loading mechanism 14 has functions of automatically arranging disorderly empty reaction vessels and loading the reaction vessels in order. The reaction disk component 15 has a function of aspirating and transferring a waste liquid into a waste liquid tank through repeated magnetic bead adsorption. The cleaning component 16 has a function of completing washing of magnetic beads and compounds to remove impurities other than the magnetic beads and the analytical compounds, including the activation liquid, the equilibrium liquid and other residual reagents. The transport module 17 has a function of transferring reaction vessels among the modules. The eluate (reaction vessels to be eluted) input conveyor line 18 has a function of transferring the cleaned reaction vessels (containing the compounds) to the multichannel liquid chromatography-mass spectrometry module.

### Automatic Sample Feeding and Discharging Module

In some embodiments, the sample preprocessing module of the invention includes the automatic sample feeding and discharging module. The collected sample is put into the automatic sample feeding and discharging module, and automatically transmitted to a sampling position for sampling or waiting for sampling or loading. Typically, the sample, such as a blood sample, is collected from a testee and then put into a test tube, and then, the test tube is put into a sample basket 113. For example, the sample basket 113 with the test tubes 1131 is put on a plate at one end 1101 of an automatic sample feeding module 110, and the sample basket is automatically transferred to a waiting area 114 and finally enters a sample disk module 116 to wait for sampling. The waiting area 114 is used for queuing, and allows the sample baskets with samples to sequentially enter the sample disk module 116 and to be arranged in sequence, and as the sample disk module rotates, a pipette is inserted into the test tubes 1131 for sampling. Of course, in the sample disk module 116, these test tubes are fixed, an automatic lid opening device is provided to remove lids of the test tubes, and then the pipette is inserted into the test tubes for sampling.

In some embodiments, the automatic sample feeding and discharging module has a routine sample feeding and discharging function and an emergency sample feeding and discharging function. The routine sample feeding module 110 and a sample exit module 111 are respectively located at two sides of a sample feeding and discharging assisting mechanism 112. The sample waiting area 114 is arranged at a same side of the routine sample feeding module and the sample exit module. The waiting area is an area for queuing, and allows the samples or sample baskets arriving in the waiting area to sequentially enter the sample disk module 116 for sampling. In some embodiments, the routine sample feeding module 110 is an area similar to a platform, and has an end 1101 for placing multiple sample baskets 113. With the help of the sample feeding and discharging assisting mechanism 112, the sample baskets are pushed into an entrance 1141 of the waiting area 114 and then into the waiting area. The waiting area is provided with a track, and the bottom of the sample basket is provided with a sliding groove. Thus, the sample basket is arranged on the track, and as the track moves, the sample basket is driven to move toward the sample disk module 116.

The sample feeding and discharging assisting mechanism 112 includes a sample feeding and discharging assisting transmission shaft 1121 and a sample shift lever 1122. The sample shift lever 1122 can rotate (left and right) and move (forward and rearward) along the sample feeding and discharging assisting transmission shaft 1121 so as to respectively assist in sample feeding and discharging. The sample feeding and discharging assisting mechanism 112 further includes a handle 1123, and the handle can be used for adjusting the direction of the sample shift lever 1122 by rotation manually or automatically. It can be understood that when the sample basket 113 needs to be fed, first, the sample basket 113 is placed in the sample basket placement area 1101 on the sample feeding module 110, and then, the sample shift lever 1122 is driven by a motor to slide to one side of the sample basket 113 along the transmission shaft 1121. The sample shift lever 1122 is at the back of the sample basket. The sample shift lever automatically rotates to the back of the sample basket 113 and pushes the sample basket 113 to move forward on the sample feeding module 110 into the track of the waiting area 114. The positions of the sample baskets and the sample shift lever 1122 can be controlled by position sensors. A plurality of sensors, such as photoelectric sensors, may be arranged in the sample basket placement area 1101. Once the sample basket is put in this area, the sensors sense the sample basket in this position, and then, the motor automatically starts to drive the sample shift lever 1122 to move to this position. After the shift lever moves to the back of the sample basket, the shift lever pushes the sample basket to pass through this area and enter the waiting area 114. When the sample basket is in the waiting area 114, the sample basket moves to an entrance 1162 of the sample disk module along the track of this area. A plurality of slots capable of fixing the sample baskets may be arranged in the sample disk module. At this time, the sample basket slot 1163 at the entrance is vacant as the sample basket at this position 1163 has completed sampling. Then, the sample basket moves out of the entrance 1163 of the sample disk module to an exit 1142 of the waiting area. Once the sensors sense a sample basket at the exit 1142 of the waiting area, it indicates that the sample basket needs to be transferred to the exit area and to return to the sample exit module 111. Only after a sample basket comes out of the sample disk module (after sampling is completed) can a new sample basket go in. This sequence can be controlled by many methods, for example, by arranging a scanning apparatus in the waiting area. When a sample basket in the waiting area needs to enter the sample disk module, the sample basket is scanned. At this time, a signal is given to a host, which indicates that a new sample basket needs to enter the sample disk module. At this time, it is required to determine whether there is a vacant position in the sample disk module 116. If not, then it is required to wait until the sample basket that has completed sampling comes out of the sample disk module. When the sample basket exiting from the sample disk module is at the exit 1142, the sensors can sense the sample basket, so that the shift lever 1122 moves forward to the back of the sample basket and pushes the sample basket to the sample exit module 111.

More specifically, the automatic sample feeding and discharging module 11 includes the routine (non-emergency) sample feeding module 110, the sample exit module 111 and the sample feeding and discharging assisting mechanism 112. The routine sample feeding module 110 is configured to load sample baskets to be tested 113. The routine sample feeding module 110 serves as a sample entrance channel. The sample baskets to be tested 113 loading large-batch sample tubes are put into this channel, and pushed into a transfer module 114 through the sample feeding and discharging assisting mechanism 112 to enter a sample loading queue. The sample basket 113 is a place carrying sample tubes. One sample basket 113 carries 5 to 10 sample tubes 1131 (test tubes), and each sample tube contains a sample therein. Generally, one testee corresponds to one sample. When the sample basket is manually put into the sample feeding module 110, as the motor of the assisting mechanism operates, the conveyor belt is driven to move, so that the sample basket 113 is sent to the transfer module 114 through the entrance 1141 and arranged in the transfer module or waiting area 114, waiting to enter the sample disk module 116 for sample loading. The so-called sample loading is to draw a certain amount, such as 10-100 microliters or other volumes, of sample, such as blood sample, thus completing sample drawing.

After the sample in the test tube in the sample basket 113 in the sample disk module is drawn, as the sample disk module rotates, the sample basket that has completed drawing is transferred to the exit 1162, and the sample basket is pushed to the exit 1142 from the limit position 1163 in the sample disk module 116. The sample basket 113 needs to leave the waiting area or the transfer module 114. Then, the sample exit module 111 is configured to load the sample baskets 115 that have completed sampling. The sample exit module 111 serves as a sample exit channel. Sample tubes that have completed sampling exit from the transfer module for sample in and out 114, and are pushed out by the sample feeding and discharging assisting mechanism 112 and finally transferred into the tested sample baskets 115. The assisting mechanism 112 here can send the sample baskets out to the waiting area 114. After sampling is completed, the sample baskets are sent out by the mechanism 112. Actually, the transfer module 114 is a transition area or structure where the sample baskets wait in the queue. After the sample basket enters the waiting area from the sample feeding module 110 through the entrance 1141, the transfer module 117 in this area transfers the sample basket into the sample disk module 116 to wait for sampling, thereby realizing sampling. After sampling is completed, the sample basket waits at the unloading exit 1142. Then, at this time, the sample exit module 111 starts working and transports the sample basket that has completed sampling to a tail end of the sample exit module 111. Of course, if there are multiple sample baskets, the routine samples are inputted into the waiting area in sequence and transferred into the sample disk module 116 by the transfer structure 117 to complete sampling. After sampling is completed, the transfer structure 117 moves back to the exit 1142, and the sample exit module 111 discharges the samples. The system operates according to this work flow. It can be understood that in a case where multiple sample baskets are fed, the sample baskets are arranged in the sample disk module 116 for sampling and then move back to the exit 1142 to complete sample discharging of the sample baskets. The sample baskets operate according to the routine sequence. For example, the sample basket No. 1 enters the entrance 1141 and waits in the queue, and then is sent into the sample disk module 116 by the transfer structure 117. The sample disk module 116 has a plurality of positions for carrying sample baskets, i.e., sample basket slots 1161. Each position carries one sample basket, and the sample carrying positions 1161 in the sample disk modules are rotatable, and sequentially realize sampling in the sample tubes 1131. When every carrying position in the sample disk module has a sample basket, for example, if there are 20 carrying positions or sample basket slots 1161, the sample basket 113 (No. 20) enters the sample disk module 116 and is arranged in the sample basket slot 1163. Before this, the sample basket 115 (No. 1) that has completed sampling exits from the sample basket slot 1163 to the exit 1142 and is moved out by the sample exit module 111, and the sample basket 113 (No. 2) enters the vacant sample basket slot 1163 through the entrance 1162 to wait for sampling in the sample disk module.

The automatic sample feeding and discharging module 11 further includes the sample disk module 116 (sampling) and the transfer module for sample in and out 117. The transfer module for sample in and out 117 is located at tail ends or a same side of the routine sample feeding module 110 and the sample exit module 111 and is capable of pushing a sample basket to be tested 113 at a tail end into the sample basket slot 1161 in the sample disk module 116. The sample disk module 116 is located at one side of the sample exit module 111 and provided with a sample basket entrance and exit 1162 (i.e. the entrance of the sample basket). Sample basket slots 1161 for loading the sample baskets to be tested 113 and the tested sample baskets 115 are arranged in the sample disk module 116 at equal intervals. It is easy to allow the sample baskets to enter the sample basket slots 1161 through the entrance 1162 and allow the sample baskets in the sample basket slots to exit from the sample basket slots. For example, the bottom of the sample basket slots is provided with a conveyor belt, or the sample basket slots may be clamped, for example, when the sensor on the sample basket slot senses a sample basket entering the slot, the structure forming the slot clamps and fixes the sample basket such that the sample basket slot can rotate as the sample disk module rotates. After the sample basket slot is clamped, it is convenient to remove the lid of the test tube. In some embodiments, the automatic sample feeding and discharging module further includes a code scanner 119, and the code scanner 119 is arranged at one side of the transfer module for sample in and out 114 and configured to scan passing sample tubes. The code scanner can record the numbers of the sample baskets entering the sample disk module 116 and scan the number of each test tube 1131 in the sample basket. Each number corresponds to one sample, and each sample corresponds to the sampled individual, which also includes personal information of the patient or testee, such as age, gender, sampling time and test items.

In some embodiments, an emergency sample loading area is arranged at the tail end of the waiting area. This area is used for emergency testing for emergencies, and samples in this area can jump the queue. The emergency sample loading area is located at a tail end of the transfer slide rail 117. The emergency sample loading area is at one side of the sample basket entrance 1141, but at the tail end of the waiting area 114. The emergency sample basket 118 is arranged at the tail end of the transfer structure. At ordinary times, the emergency sample loading area 117 is vacant. Once a sample basket is put in this area, it indicates that the sample in the sample basket needs emergency testing and needs to be tested in priority. There are many methods to identify the need for emergency testing. For example, a light-emitting element and a light-receiving sensor may be arranged in the emergency sample loading area. When there is no emergency sample basket, the sensor is capable of receiving light. Once this area 117 is occupied by the emergency sample basket, it indicates that the sample basket needs emergency sampling and testing. Once such an instruction is received, the routine sample feeding module 110 stops feeding samples, the other sample baskets in the queue sequentially enter the sample disk module, and the sample basket that has completed sampling from the sample disk module enters the sample exit module 111 through the exit 1142. At this time, only the emergency sample basket 118 stays in the transfer module 114, and a vacant sample basket slot is reserved in the sample disk module. The transfer mechanism in the waiting area sends the sample basket 118 into the sample basket slot of the sample disk module 116. Then, the sample basket slot is controlled to rotate, such that the sample basket slot carrying the emergency sample basket is rotated to the sampling position for sampling. After sampling is completed, other normal or routine samples are processed. After emergency sampling is completed, the sample disk module is rotated to the position of the last sampling to process routine samples.

Thus, emergency sampling is added to routine sampling, which is equivalent to a queue jumping mode and can adapt to different demands. Of course, expect for the transfer of emergency samples, the sample loading module can operate according to the normal sequence, or an emergency processing station or action may be set in other subsequent modules, for example, the sample loading module, the reaction module, the multi-stage cleaning component, the eluate input conveyor line and the filter assembly all process the emergency sample in priority such that the mass spectrometry test result of the emergency sample comes out first.

### Sample Loading Module

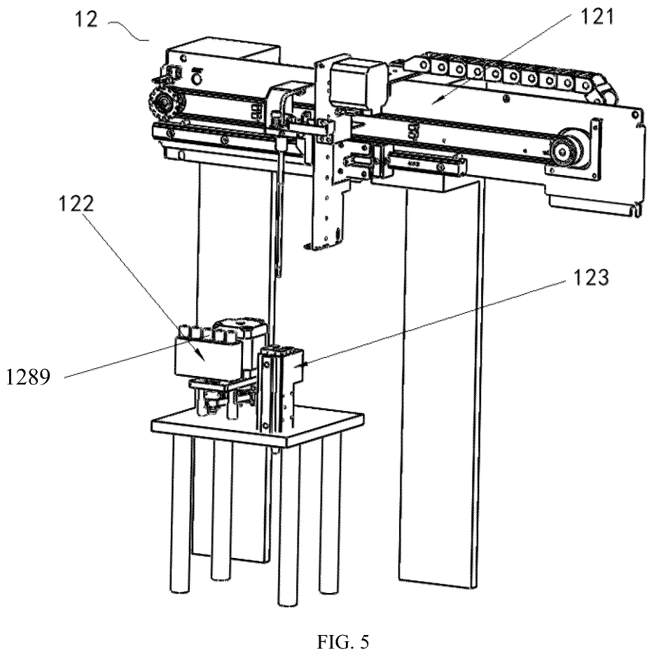

As shown in FIG. 5, the invention provides an automatic sample loading module which functions to absorb samples from the sample disk module 16 for subsequent automatic processing. In some embodiments, the sample loading module 12 is configured to suck samples (specifically, suck samples from the test tubes in the sample baskets in the sample disk module 116) from the automatic sample feeding and discharging module into reaction vessels 1226 and configured to perform shaking and mixing and clean a pipette. A pipetting module 121 here functions to absorb samples and add the samples into the reaction vessels.

Before adding the samples into the reaction vessels, the reaction vessels have activated and cleaned magnetic beads, internal standards or other solution reagents for different samples. For example, internal standards, magnetic beads, diluents, equilibrium liquids and eluates are all absorbed from the reagent disk 138. Of course, in some embodiments, some liquids (expect the liquid sample) may be added from a liquid adding needle 164 in the multi-stage cleaning component. In the invention, the liquid adding needle may be configured to add washing liquids and eluates only, and of course, may also be configured to add other liquids. The multi-stage cleaning component may be provided with a plurality of liquid adding needles, and each liquid adding needle is configured to add a different liquid, which will be described in detail later.

In some embodiments, the sample loading module 12 includes a pipetting module 121, configured to absorb samples such as blood samples and have a function of cleaning the pipette.

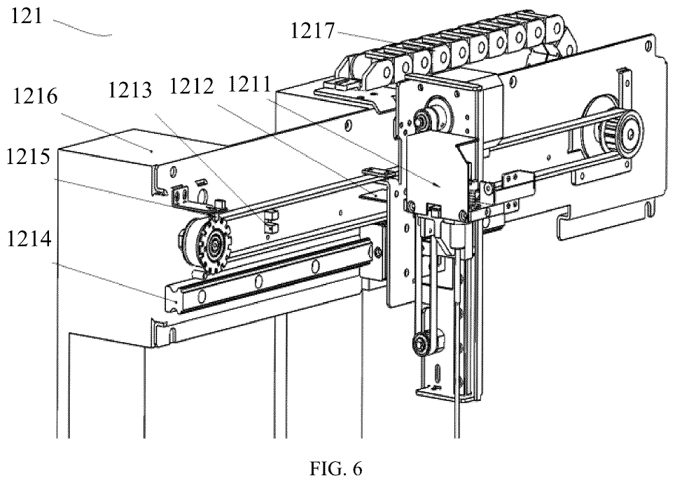

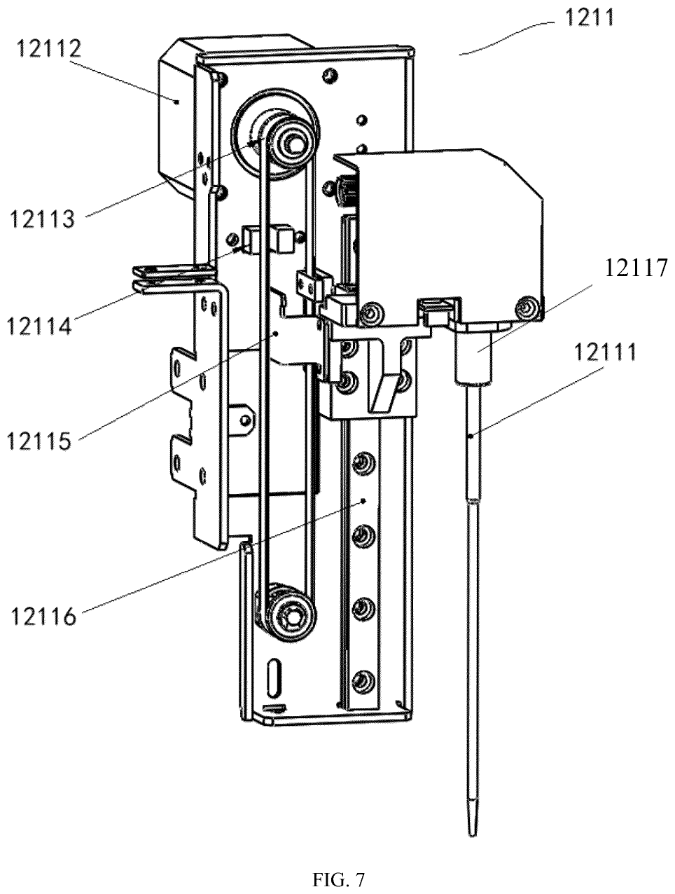

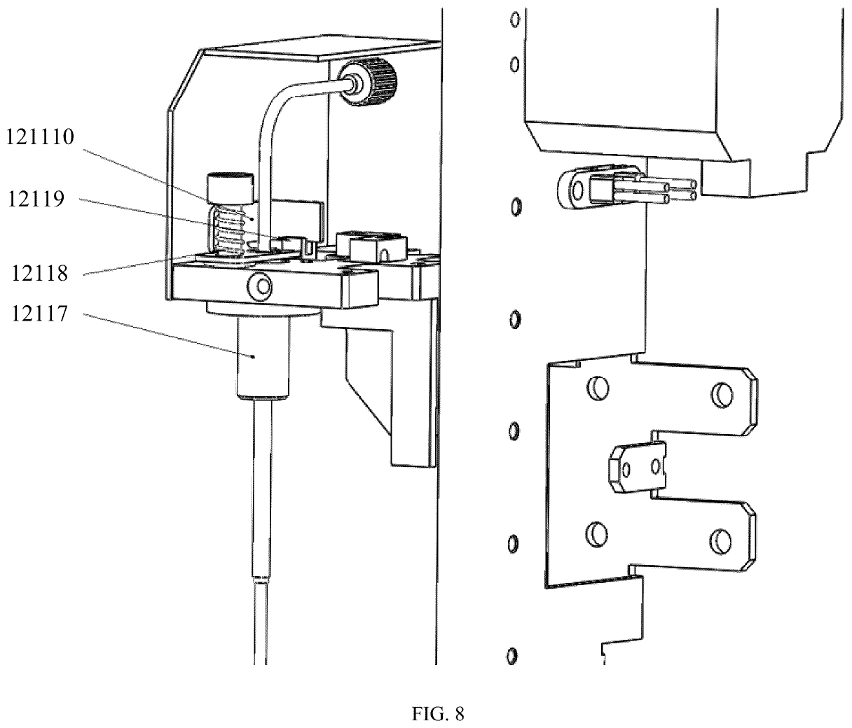

As shown in FIG. 6, in some embodiments, the pipetting module 121 includes a pipette module 1211, including the pipette and a structure for fixing the pipette. As shown in FIG. 7 to FIG. 8, the pipette module 1211 includes a structure for driving the pipette to move up and down and a structure for driving the pipette to translate left and right, so that the pipette can absorb and transfer the liquid. The liquid here includes the liquid sample. In some embodiments, the pipette module 1211 includes a pipette 12111, a pipette up-and-down movement motor 12112, a pipette movement timing belt 12113, a pipette zeroing sensor 12114, a pipette zeroing baffle 12115, a pipette slide rail assembly 12116 and a pipette pipetting motor 12117. In some embodiments, the module further includes a pipette auxiliary spring 12118, a pipetting action sensor 12119 and a pipetting action zeroing baffle 121110. The pipette up-and-down movement motor 12112 drives the pipette 12111 to move up and down through the pipette movement timing belt 12113. The pipette slide rail assembly 12116 guides the pipette 12111 to move up and down, so that the pipette module 1211 moves along the slide rail and is kept fixed in the up- down direction. The pipette pipetting motor 12117 12112 drives the pipetting action zeroing baffle 12115 to move up and down, the pipetting action sensor 12119 is configured to detect a position of the pipetting action zeroing baffle 12115, and when the pipette zeroing sensor 12114, serving as a limit position sensor of the pipetting action zeroing baffle 12115, detects the pipette zeroing baffle 12115, it is determined that the pipette is at a zero position in an up-down direction in the pipetting operation, i.e. the starting position of the pipette. Accurate control of the initial or starting position in the up-down direction can control the depth of the pipette inserted into the test tube each time and keep the sampling position accurate. A stable volume of the sample absorbed is controlled by a pump connected with the pipette.

In some embodiments, the pipetting module 121 further includes a pipetting limit baffle 1212 and a pipetting limit sensor 1213, and when the pipetting limit sensor 1213 detects the pipetting limit baffle 1212, transmission is stopped such that the conveyor belt stops moving, and it is determined that the pipette is at a zero position in a left-right direction in the pipetting operation, i.e., the starting position in the left-right direction. In this way, the movement direction and position of the pipette 12111 can be accurately controlled through the sensor for the position in the up-down direction and the sensor for the position in the left-right direction, thereby realizing more accurate control. The accurate position control here is to allow the pipette to be correctly inserted into the test tube that needs to be sampled, and then to be accurately inserted into the reaction vessel after absorbing the sample, thereby avoiding sampling or sample application errors. The sample basket has a plurality of sample test tubes therein, and the module 122 has a plurality of reaction vessels 1289. To make the sample in each test tube enter each individual reaction vessel, the position control of the pipette needs to be more accurate, and sampling needs to be in one-to-one correspondence to sample application without errors. Moreover, after sampling and sample application of the individual sample are completed, the pipette needs to be cleaned. All of these need an accurate position of the pipette.

In some embodiments, the pipetting module 121 further includes a pipetting translation motor 1214, a pipetting slide rail assembly 1215, a pipetting translation sensor module 1216 and a cable carrier 1217. The pipetting translation motor 1214 is configured to drive the pipette module 1211 to translate. The pipetting slide rail assembly 1215 is configured to guide the pipette module 1211 to translate through the belt. The pipetting translation sensor module 1216 is arranged at one end of the pipetting slide rail assembly 1215 and configured to accurately detect a translation position and feed back a signal. The cable carrier 1217 is configured to protect communication and power cables of the pipette module and allow the cables to move together with the pipette module 1211.

It can be understood that the sample absorption of the pipette, the sample application to the reaction vessel and the cleaning of the pipette are all realized based on the fact that the pipette is in communication with an air pump, and the suction and air discharge of the air pump realize sample absorption, sample delivery and cleaning of the pipette.

In some embodiments, the pipetting module further includes a sample shaking and mixing module 122. After the pipette absorbs the sample from the sample tube in the sample basket and adds the sample into the sample vessel, the sample needs to be shaken and mixed. In this case, magnetic beads are added to the sample vessel through the reaction module, and the magnetic beads are allowed to be thoroughly mixed and in contact with the sample, so that the analyte is adsorbed or captured by the magnetic beads and the diluent can be extracted from the sample conveniently.

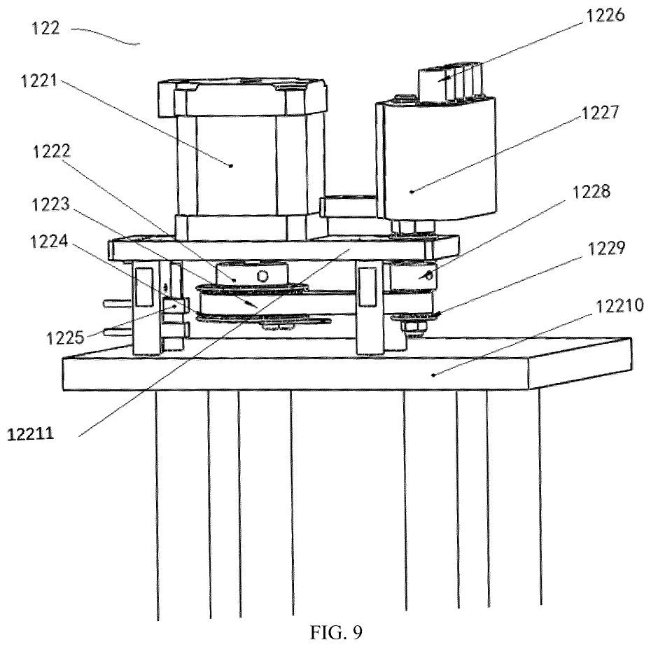

As shown in FIG. 9, the sample shaking and mixing module 122 includes a sample mixing cleaning seat 12210, and a sample shaking motor 1221, a sample shaking motor coupling 1222, a sample shaking timing belt 1223, a sample shaking driving pulley 1224, a rotational speed sensor 1225, reaction vessels 1226, a reaction vessel carrier 1227 for carrying the reaction vessels, a driven shaft coupling 1228 and a sample shaking driven pulley 1229 are arranged on the sample mixing cleaning seat. The motor 1221 is arranged on a base 12211, and the sample shaking motor 1221 on the base drives the reaction vessel carrier 1227 to perform shaking and mixing through the sample shaking motor coupling 1222, the sample shaking timing belt 1223 and the sample shaking driving pulley 1224, so that the reaction vessels 1226 with the samples are subjected to shaking and mixing. The base 12211 is fixed to the sample mixing cleaning seat 12210 through pillars, and all the other mechanisms capable of moving or shaking (the sample shaking motor coupling 1222, the sample shaking timing belt 1223, the sample shaking driving pulley 1224, the rotational speed sensor 1225, the reaction vessels 1226, the reaction vessel carrier 1227 for carrying the reaction vessels, the driven shaft coupling 1228 and the sample shaking driven pulley 1229) are not fixedly connected with the base, which can make the sample shake. Actually, the sample mixing cleaning seat 12210 is provided with the above shaking power and power transmission, and the generation and transmission of these powers are independent of the transmission on the sample mixing cleaning seat 12210.

At this time, the reaction vessel 1226 contains the sample and some reagents, mainly the magnetic beads and the sample, and these reagents need to be shaken to promote the reaction. It can be understood that the reaction vessel carrier 1227 can carry 1 or more reaction vessels, which is generally the same as the number of the test tubes carried in the sample basket. When emergency processing is needed, if there is one sample, then the reaction vessel carrier 1227 may carry one reaction vessel for shaking. The reaction vessel here is removed from a shaking table 131 on the reaction module and transported to the reaction vessel carrier 1227 by a manipulator 17 described later.

In some embodiments, the sample mixing cleaning seat 12210 of the pipetting module includes a sample cleaning pool module 123. The sample cleaning pool module 123 stores a pipette cleaning liquid therein. When cleaning is needed, the pipetting module 121 dips the pipette 1211 into the pipette cleaning liquid, thereby completing cleaning and avoiding cross contamination. Every time the pipette 1211 absorbs one sample into the reaction vessel, the pipette 1211 needs to be cleaned. After cleaning is completed, the pipette absorbs the next sample and applies the sample into another reaction vessel. A cleaning pool is connected to a “solvent tray station” and a “scrap and waste liquid box” of the “multichannel liquid chromatography-mass spectrometry module” through tubes so as to replenish the cleaning liquid and remove the waste liquid at any time.

A sample vessel is arranged on the same cleaning seat to receive the sample applied from the pipette 1211, and the cleaning module is designed near the reaction vessel carrier 1227, which minimizes the movement distance of the pipette 1211. Generally, the pipette 1211 is first inserted into the sample tube in the sample basket in the sample disk module 16 to absorb the sample, then moved to the top of the reaction vessel carrier 1227 to apply the sample into the sample vessel, drawn out of the sample vessel and moved to the cleaning module to clean the pipette 1211, and then moved into the sample disk module to absorb the sample in the next sample tube. The pipette 1211 reciprocates like this, which reduces repetitive motions and allows the pipette to move based on the principle of proximity, thereby improving the processing efficiency and reducing the occupied space.

In the invention, the pipetting module integrates the functions of sample absorption, shaking and cleaning. This facilitates absorption and mixing of the sample as well as the addition of the internal standard and the diluent, so that the sample can be uniformly mixed with these solutions. In addition, every time a liquid is added, the pipette needs to be cleaned, which avoids cross contamination. This integration enhances the convenience of processing, realizes the operation based on the principle of proximity, reduces the operation distance and makes the whole system smaller in size, but does not reduce the steps of sample processing.

### Reaction Module

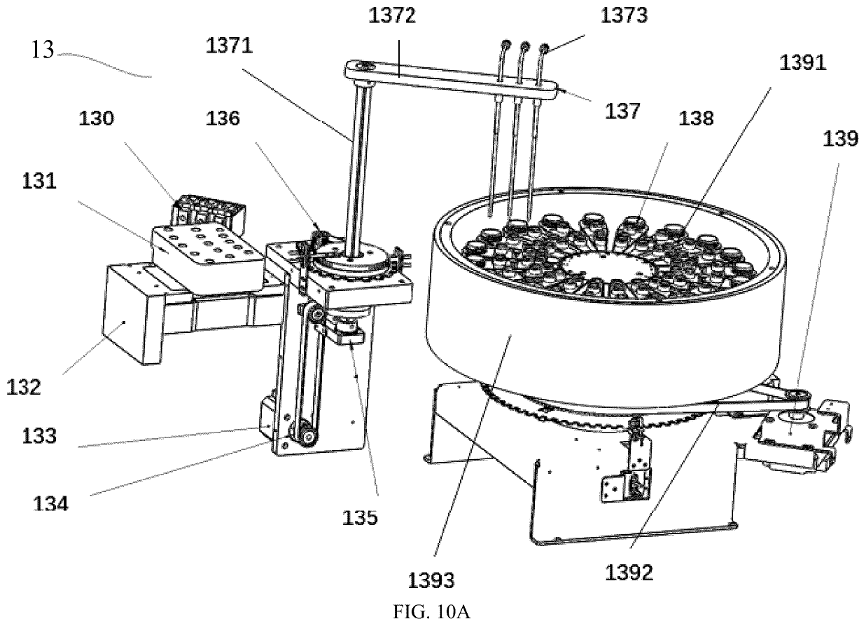

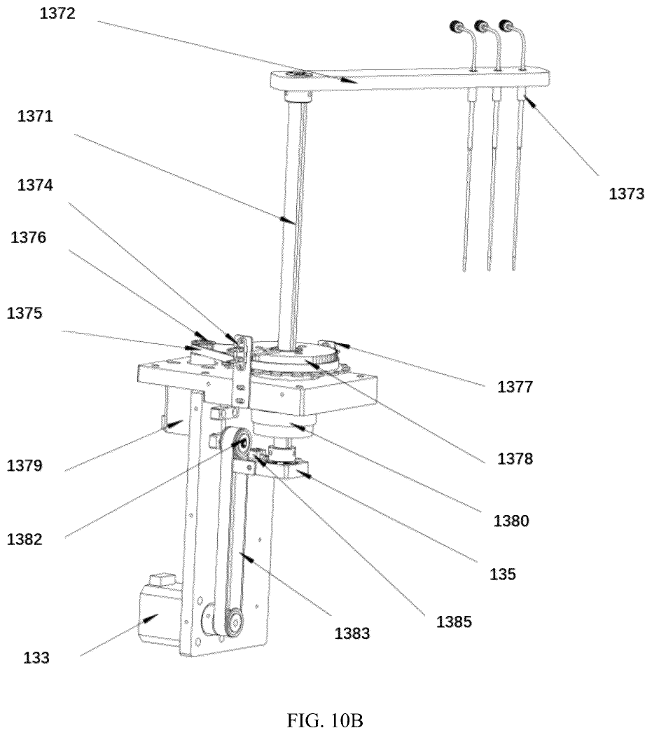

In some embodiments, the sample preprocessing module further includes a reaction module 13, in which the activation liquid (magnetic beads), the equilibrium liquid, the diluent, the internal standard and other solutions are added to the reaction vessels. The addition of some of these liquids needs shaking and mixing. As shown in FIG. 10A, the reaction module 13 is configured to store the activation liquid (activation of magnetic beads), the equilibrium liquid and the diluent and complete addition, shaking and mixing of the activation liquid and the equilibrium liquid. First, in terms of the activation of the magnetic beads and the addition of the equilibrium liquid, every time after the addition is completed, it is required to remove the activation liquid and the equilibrium liquid and then add the internal standard, and the place where the waste liquid is removed is the magnetic bead processing module. Then, the reaction vessel is transferred to the sample loading module for the addition and shaking of the sample and the addition of the diluent.

In some embodiments, the reaction module includes the following steps: preparation of reaction vessels (empty reaction vessels), and addition of the activation liquid into the reaction vessels in advance, where the activation liquid contains the magnetic beads. Of course, in general cases, the magnetic bead and the activation liquid may be stored in one reagent bottle, or the magnetic beads and the activation liquid may be stored separately and then added to the empty reaction vessel. Then the activation liquid is removed, and the equilibrium liquid is added. After the equilibrium liquid is added, the equilibrium liquid is discharged, leaving only the magnetic beads in the empty vessel. Every time after the liquid is added, the liquid needs to be removed, which is performed in the magnetic bead disk and the multi-stage cleaning component.

Specifically, the operation of the reaction module is described below. The reaction module 13 includes a reaction cleaning pool module 130, a reaction vessel carrier 131 and a reaction shaker 132. The reaction vessel carrier 131 is located on the reaction shaker 132, and the reaction cleaning pool module 130 is located beside the reaction vessel carrier 131, so that the reagent needle can be cleaned conveniently after adding the reagent.

In some embodiments, the reaction module 13 includes an aspirating needle component for absorbing and transmitting reagents, which includes a reagent aspirating needle lifting motor 133, a reagent aspirating needle lifting transmission component 134 (pulleys and belt), a reagent aspirating needle lifting rod support 135, a reagent aspirating needle rotating motor component 1379 and a reagent aspirating needle component 1373. A supporting rod 1371 is arranged on the support 135. The supporting rod 1371 is provided with a support arm 1372 which is provided with 3 or more aspirating needle components 1373. The support 135 is fixedly connected with the supporting rod 1371 and the support arm 1372, and drives the reagent aspirating needles 1373 to move up and down as the support moves up and down. Similarly, the aspirating needles are in communication with the air pump, and as the air pump sucks air to form a subatmospheric or negative pressure and discharges air to form a positive pressure, the aspirating needles absorb and release the liquid. In some embodiments, the aspirating needle component further includes position sensors 1374 (position A) and 1377 (position B) corresponding to each other around a turntable 1378, which are configured to sense the angle of rotation. The component further includes a rotating motor driving pulley 1376, a rotating belt 1375, a rotating driven pulley 1378 and a rotating motor 1379. The motor rotates to drive the driving pulley 1376 to rotate, and the driving pulley drives the driven pulley 1378 to rotate through the belt, thereby driving the supporting rod 1371 to rotate and also driving the support arm 1372 on the supporting rod 1371 to rotate. The rotation of the support arm drives the aspirating needle component 1373 to rotate. The driven pulley is fixedly connected to the supporting rod 1371, and the angle of rotation is controlled through the position sensors 1374, 1377. The rotating motor, the driven pulley, the belt and the position sensors are integrated on one plate and can move up and down as a whole.

In some embodiments, the lifting transmission component 134 includes a lifting stop block 1380, a lifting connecting block 1381, lifting pulleys 1382, a lifting belt 1383, a lifting motor 133 and a lifting position detection sensor 1385. A lifting guide rod 1371 is connected to the lifting connecting block 135, and when the motor rotates, the belt 1383 is driven to move, and the lifting guide rod is driven by the lifting belt to move up and down. The lifting position detection sensor 1385 is configured to detect the lifting position, the lifting pulleys 1382 are connected to the lifting motor, and the lifting stop block 1380 is configured to limit and guide the lifting guide rod 3. Actually, the belt is connected to the connecting block 135, and the rotation of the belt causes the change in position, thereby causing the lifting guide rod 1371 to move up and down.

The rotation and the movement in the up-down direction drive the aspirating needles to move, so that the liquid is transferred from the reagent unit 1383 to the reaction vessel.

In an embodiment, the reaction module 13 includes a reagent unit 1393 for storing reagents (storing the activation liquid (containing the magnetic beads), the equilibrium liquid and the eluate), which includes reagent vessels 138 and a motor 139 for driving a reagent turntable 1391 to rotate. The reagent vessels storing different reagents are loaded in the reagent turntable 1391. The motor drives the belt 1392 connected to the turntable 1391 so as to make the turntable rotate. In this way, the aspirating needles 1373 of the reagent aspirating needle component 137 are inserted into these reagent vessels to aspirate the reagents and transfer the reagents into the sample vessels 1226 for reaction.

In some embodiments, the aspirating needle component is located between the unit 1393 for storing reagents and the sample processing module, which facilitates the transmission of the solutions. In some embodiments, when the reaction vessel carrier 131 is arranged in the form of 3*5 (if there are more reagent aspirating needles in the reagent aspirating needle component, the array could be larger), blank reaction vessels 1226 are arranged in the reaction vessel carrier 131 according to certain rules, reagents in the reagent vessels 138 are added to the reaction vessels 1226 through the reagent aspirating needle component 137, the reagent aspirating needle lifting motor 134 drives the reagent aspirating needle component 137 to move up and down along the reagent aspirating needle lifting rod support 135 through the reagent aspirating needle lifting transmission component 134, the reagent turntable motor 139 drives the reaction vessel carrier 131 to rotate to facilitate reagent selection, and the reagent aspirating needle rotating motor component 136 drives the reagent aspirating needle component 137 to rotate. When the reagent solution is put into the reaction vessel, the reaction vessel may be inserted into the cleaning component 130 to clean the aspirating needles 1373, mainly to prevent the aspirating needle 1373 from absorbing different liquids. In some embodiments, in the reaction module, the activation liquid (containing the magnetic beads) is added to the blank reaction vessel in the shaker 131, then the activation liquid is removed, the equilibrium liquid is added, the equilibrium liquid is removed, and finally, the magnetic beads are retained in the reaction vessel, or further, the content solution is added. When there are magnetic beads, the cleaning and activation of the magnetic beads are both performed on the magnetic bead disk.

The reaction cleaning pool module 130 contains a cleaning agent and is configured to clean the reagent aspirating needles 1373, and after the reagent is added to the reaction vessel, the reaction shaker 132 performs shaking and mixing on the cleaning agent.

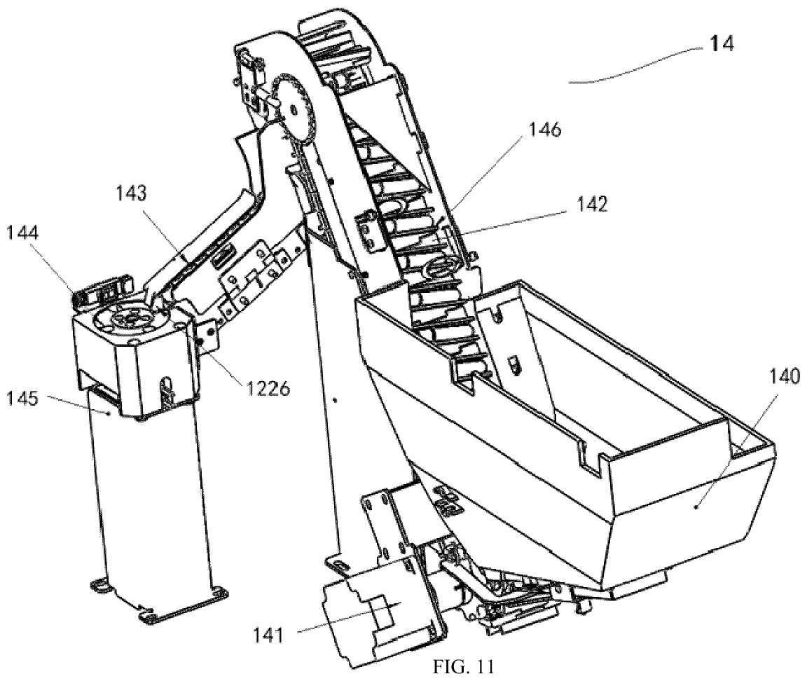

As shown in FIG. 11, the reaction vessel loading mechanism 14 is configured to automatically arrange disorderly empty reaction vessels and load the reaction vessels in order. Specifically, the reaction vessel loading mechanism 14 includes a bulk compartment 140, a roll-on roll-off motor 141, a roll-on roll-off conveyor belt 142, a pre-loading channel 143, a reaction vessel transport tray 144 and a reaction vessel transport tray motor 145, the roll-on roll-off motor 141 is configured to drive the roll-on roll-off conveyor belt 142 to move, the pre-loading channel 143 is arranged at one side of an upper part of the roll-on roll-off conveyor belt 142 and is in communication with the roll-on roll-off conveyor belt 142, the bulk compartment 140 is arranged at a starting end of the roll-on roll-off conveyor belt 142, and the roll-on roll-off conveyor belt 142 is provided with roll-on roll-off partitions 146; and when the roll-on roll-off conveyor belt is started, disorderly reaction vessels in the bulk compartment 140 enter gaps between the roll-on roll-off partitions 146 one by one so as to orderly enter the pre-loading channel 143 through the roll-on roll-off conveyor belt 142 and then are pushed into the reaction vessel transport tray 144 one by one through the pre-loading channel 143, and the reaction vessel transport tray 144 rotates the obtained reaction vessels to an outer side such that the reaction vessels are ready to be picked up. For this loading mechanism, reference can be made to U. S. Pat. No. US11,440,751, and each specific embodiment of this patent is used as an embodiment of the invention. With this loading mechanism, the reaction vessels are arranged in order on the transport tray 144, with the openings of the reaction vessels facing up. Then, the reaction vessels are transferred by the manipulator.

### Magnetic Bead Processing Module

After the sample and the internal standard are added to the reaction vessel containing the magnetic beads and the diluent is optionally added through the sample loading module, in order the make the magnetic beads thoroughly contact the sample, the magnetic beads need to adsorb the analyte such that the analyte can be separated from the magnetic beads to enter the next procedure. The module where the magnetic beads are processed may also be called the “magnetic bead processing module”. The preprocessing before the magnetic beads contact the sample, the separation of the magnetic beads from the sample after the magnetic beads contact the sample, the washing of the magnetic beads, and the elution of the analyte are all completed in this module.

Therefore, the invention provides a module for eluting the analyte from the magnetic beads, which includes discharging the magnetic bead activation liquid, discharging the equilibrium liquid, discharging the diluent, discharging other washing liquids and discharging the sample to finally retain the magnetic beads and the analyte adsorbed on the magnetic beads, and then separating the adsorbed analyte from the magnetic beads by eluting the magnetic beads, so as to enter the next stage, for example, processing before liquid chromatography, such as the filtering process.

This module includes a magnetic reaction disk component 15 and a multi-stage cleaning component 16. Through the cooperation between the magnetic reaction disk and the multi-stage cleaning component, the magnetic beads contact and are cleaned by the assisting liquid reagent, so that the analyte can be retained on the magnetic beads as much as possible, thereby removing impurities or improving the subsequent test performance. The liquid reagents include the magnetic bead activation liquid, the equilibrium liquid, the internal standard solution, the diluting solution and the sample (blood, urine or saliva) as well as many other solution reagents involved in sample extraction. Before these liquids are discharged, shaking may be performed in the sample loading module 12 or the reaction module 13, such that the magnetic beads are separated from the solution. In some embodiments, the reaction disk component 15 is configured to adsorb the magnetic beads many times, wash the magnetic beads many times, and absorb and transfer the waste liquid to the waste liquid tank (the magnetic beads are retained). The “washing” here is to clean the magnetic beads and remove the impurities or the waste liquid so as to retain the analyte on the magnetic beads as much as possible and reduce the presence of other substances (impurities), thereby reducing the content of impurities other than the analyte in the eluate during the subsequent analyte elution, and improving the separation accuracy of the subsequent liquid chromatography apparatuses. The waste liquid here may include any liquid that contacts the magnetic beads, such as the activation liquid, the equilibrium liquid, the internal standard solution, the diluting solution and the sample (blood, urine or saliva). After the magnetic beads contact the above liquids (individually or together), it is expected to wash away the residues while ensuring more analyte to be adsorbed to the magnetic beads. The washing liquid may be any other solutions, such as buffer, purified water, deionized water, etc. During the washing process, it is required to make the washing liquid be mixed and in contact with the magnetic beads and then draw the washing liquid away while retaining the magnetic beads in the reaction vessel.

Therefore, in some embodiments, the reaction disk component 15 includes a reaction disk motor 150, a reaction disk 151 and a reaction disk base 152, the reaction disk 151 is arranged on the reaction disk base 152, and the reaction disk motor 150 drives the reaction disk 151 to rotate, so as to drive the reaction vessels on the reaction disk to rotate. The reaction disk 151 has a housing 154 outside, which is generally fixed. The housing is provided with a magnetic module 153, the magnetic module 153 includes at least one group of magnets, and each group of magnets includes two magnetic sheets 154 respectively corresponding to a feed port and a discharge port. After the reaction vessels are put in, the magnetic beads are fixed to inner walls of the reaction vessels by means of the attraction of the magnets. When the reaction disk 151 rotates, the reaction vessel leaves the places where the magnets are arranged on the housing, and the magnetic beads adsorbed and fixed to the reaction vessel are released. According to the intervals between the reaction vessels, a plurality of groups of magnets may be arranged, so that the magnetic beads in the reaction vessels are adsorbed to the inner walls of the reaction vessels. Then, the waste liquid may be removed, and the magnetic beads may be washed many times. The removal of the waste liquid and the washing may be performed repeatedly. Of course, when no sample is added, the activation liquid may be added to the reaction vessel to activate the magnetic beads, then the activation liquid is removed, the equilibrium liquid is added, the equilibrium liquid is removed, the sample is added and mixed, the diluent and the internal standard solution may be added, and then, the other waste liquids are removed while the magnetic beads are retained. When the magnetic beads are retained, the washing liquid may be added to wash the magnetic beads. During all these processes, the magnetic beads are fixed by the magnets, and the liquid is discharged. The magnetic beads may be fixed, released and fixed repeatedly.

As the reaction disk 151 rotates, the magnetic beads in the reaction vessel are fixed and released repeatedly. During this process, the waste liquid in the reaction vessel needs to be removed, and sometimes it is required to inject other liquids (washing) after the removal. This repeated removal and liquid addition structure is completed by the multi-stage cleaning component 16.

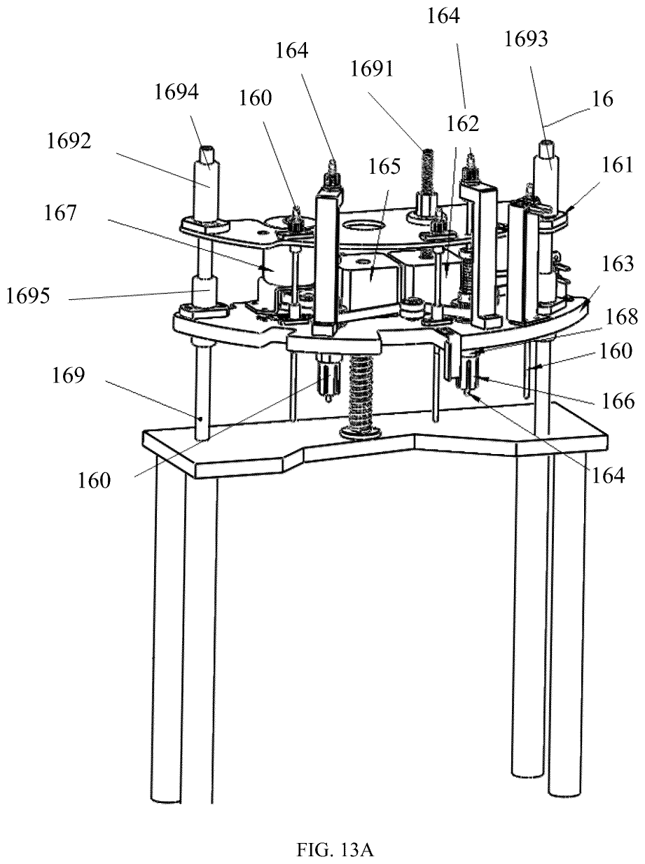

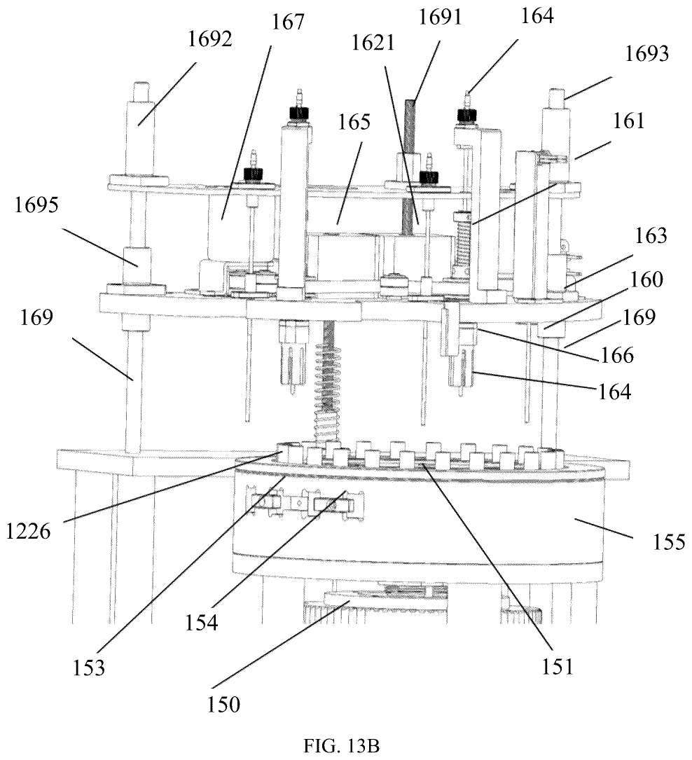

As shown in FIG. 13A, the multi-stage cleaning component 16 includes a waste liquid aspirating needle 160. An outside of the waste liquid aspirating needle 160 is coated with Teflon, such that there is no residue on an outer wall after the waste liquid is sucked out. The waste liquid aspirating needle 160 is mounted on a waste liquid aspirating needle moving layer 161, and the waste liquid aspirating needle moving layer 161 is driven by a waste liquid aspirating needle moving layer movement motor 162 to move up and down such that the waste liquid aspirating needle 160 reaches an aspiration position in the reaction vessel to draw the waste liquid.

The motor 162 drives the moving layer 161 to move up and down through a transmission shaft of the motor. The transmission shaft is fixedly connected to a threaded rod 1691. The moving layer is movably fixed to the threaded rod of the motor through a plurality of sliding rods 1692, 1693. When the motor rotates, the threaded rod 1961 also rotates. Through the fit between the thread of the threaded rod and the thread of the moving layer 161 (the threaded rod runs through the hole in the moving layer and forms a fit with the thread therein), the moving layer 161 can move up and down. For example, when the motor rotates clockwise, the moving layer 161 moves down, and when the motor rotates counterclockwise, the moving layer 161 moves up. Position fixing blocks 1694, 1695 are arranged on the sliding rods to limit the moving distance of the moving layer 161 and also ensure the accuracy of the moving direction of the moving layer 161, preventing the moving layer from deviation in the left-right direction.

Generally, the reaction disk 151 does not move up and down but rotates, and the waste liquid aspirating needle moving layer 161 is driven by the motor to move up and down so as to be inserted into the reaction vessel to draw the waste liquid or residual liquid.

The multi-stage cleaning component 16 further includes a liquid adding layer 163, the liquid adding layer 163 is located below the waste liquid aspirating needle moving layer 161, the liquid adding layer 163 is provided with a liquid adding needle 164, and the liquid adding layer 163 is driven by a liquid adding layer motor 165 to move up and down, thereby driving the liquid adding needle 164 to move up and down for liquid addition. A reaction vessel control component is arranged below the liquid adding layer 163. The reaction vessel control component includes a reaction vessel claw 166. When the liquid adding layer 163 moves down, the reaction vessel claw 166 grips the reaction vessel 1226 in the reaction disk component 15, the liquid adding needle 164 injects a cleaning liquid in air, and then a dropper moving motor 167 drives a reaction vessel dropper 168 to move down such that the reaction vessel 1226 is pushed out back into the reaction disk component 15. In some embodiments, in order to facilitate liquid addition, the liquid adding needle 164 is arranged at a center of the reaction vessel claw 166, and after the reaction vessel claw picks up the reaction vessel, the liquid adding needle 164 extends into the reaction vessel to add the liquid. In FIG. 13A, there are two reaction vessel control components provided, which can realize pickup and liquid injection of two reaction vessels. Correspondingly, two waste liquid aspirating needles are provided to draw the waste liquid.

The motor is fixedly connected to the threaded rod, and the liquid adding layer 163 is in a threaded fit with the threaded rod, so that the liquid adding layer 163 can move up and down through the rotation of the threaded rod. Similarly, the liquid adding layer 163 is also located on the sliding rods 1692, 1693 and moves up and down along the sliding rods. It can be understood that the waste liquid aspirating needle 160 is connected to the air pump to aspirate the waste liquid, and the liquid adding needle 164 is also connected to the air pump to add the liquid, which are easy to realize. In some embodiments, the reaction vessel control component is further provided with a vessel push rod 5, configured to push the reaction vessel out of the reaction vessel claw 166 and back to the specific position of the turntable 151.

In some embodiments, the waste liquid absorption and liquid addition are respectively provided on two moving plates, for example, the waste liquid layer 161 and the liquid adding layer 163. The two layers are driven by the motors to move, and the waste liquid layer 161 is located above the liquid adding layer 163, but the up-and-down sliding trails of both of the two layers are controlled through the plurality of sliding rods 1692, 1693. In some embodiments, the two motors 165, 162 are both mounted on the liquid adding layer 163, which facilitates the pickup and dragging of the reaction vessel.

The process of multi-stage cleaning of the reaction vessels will be described with reference to FIG. 13B.

Waste liquid aspiration: As shown in FIG. 13B, the reaction disk rotates, so that the reaction vessel 2 rotates to below the 1st waste liquid aspirating needle 160. The aspirating needle moving layer 161 is driven by the waste liquid aspirating needle moving layer movement motor 162 to move down until it is below the liquid level in the reaction vessel. The waste liquid aspirating needle 160, which is connected to the pump, draws the waste liquid other than the magnetic beads and the analyte out of the reaction vessel under the suction of the pump. The waste liquid aspirating needle 160 has an appropriate length, such that the aspirating needle moving layer 161 does not contact the liquid adding layer moving plate 163 when moving down while the waste liquid aspirating needle 160 has already extended into the reaction vessel and aspirated the waste liquid, such as the activation liquid, the equilibrium liquid, the sample or the diluent. At this time, the magnetic beads are adsorbed and fixed by the magnets on the housing 155 of the reaction disk 151. In this case, the motor 162 controls the moving layer 161 to move to aspirate the waste liquid, and the liquid adding layer 163 may be kept still.

Liquid addition: The reaction disk 151 is moved to below the reaction vessel claw 166, and then the motor 165 is started to drive the liquid adding layer 163 to move down such that the reaction vessel claw 166 picks up the reaction vessel. The specific design is as follows: The reaction vessel claw 166 is formed by a plurality of elastic pieces, and the reaction vessel is generally made of glass or plastic. The inner diameter formed by these elastic pieces is not much different from the diameter of the reaction vessel. When the plurality of elastic pieces of the reaction vessel claw 166 move down, the elastic pieces are sleeved on the outer wall of the reaction vessel. The elastic pieces can grip the reaction vessel and make the reaction vessel leave the position in the reaction disk 151 by the rebound force due to the elasticity. While the reaction vessel claw grips the reaction vessel, the liquid adding needle 164 in the reaction vessel claw extends into the reaction vessel. The liquid adding needle 164 in the reaction vessel injects the liquid (the cleaning liquid, the washing liquid or the eluate) into the reaction vessel under the action of the pump. Of course, the liquid adding layer 163 may also be moved down, the reaction vessel may be fixed by the reaction vessel claw 166 without leaving the reaction disk 151, and at this time, the liquid addition can also be realized.

Whether the reaction vessel is aligned with the reaction vessel claw 166 and whether the waste liquid aspirating needle is correctly inserted into the reaction vessel can be identified by a plurality of sensors, which is a common technical means in the art.

After the reaction vessel is picked up by the reaction vessel claw 166 and leaves the reaction disk 151, making the reaction vessel leave the reaction vessel claw 166 also needs to be completed. Therefore, in the invention, a vessel pushing structure is provided. This structure includes a push rod 5. The push rod 5 is hollow. The liquid adding needle 161 runs through the push rod and is located in the reaction vessel claw 166, but the lower end of the push rod is not located at the upper part of the reaction vessel claw 166. When the reaction vessel claw 166 picks up the reaction vessel, the lower end of the push rod 5 does not contact the rim of the reaction vessel. When the push rod needs to move, the motor 162 is started, so that the waste liquid layer 161 moves downward, and thus moves downward along the liquid adding layer 162 and pushes the upper end of the push rod 5 to move downward, thereby pushing the rim of the reaction vessel to leave the reaction vessel claw and making the reaction vessel inserted to the designated position in the reaction disk.

In some embodiments, a spring is arranged under the push rod. The spring has two functions. First, the spring can control the descending speed of the push rod, thereby reducing mechanical errors. When a motor with low price but not very precise control is used, the spring functions to make the push rod move slowly and reduce the pushing force properly. Second, after the pushing action is finished, the push rod 5 needs to return to its initial position, i.e., to the upper part in the reaction vessel claw 166, and at this time, the spring can push the push rod back to the initial position.

Similarly, the threaded rod of the motor that drives the liquid adding layer to move is also provided with a spring. When the liquid adding layer moves downward, it applies a force to the spring, and the spring gives a reacting force to the liquid adding layer 163, which is to make the reaction vessel claw 166 better cooperate with the reaction vessel. If there is no spring, the position needs to be controlled accurately, and the reaction vessel claw 166 and the reaction vessel are easily damaged. With the spring, the reaction vessel claw 166 can come into contact with the reaction vessel slowly. The cooperation of the motion of the motor and the spring makes the reaction vessel claw contact and clamp the reaction vessel in a “soft” landing manner. In this way, there is no need to use an expensive and precise motor, and an ordinary motor will suffice, thereby saving the cost.

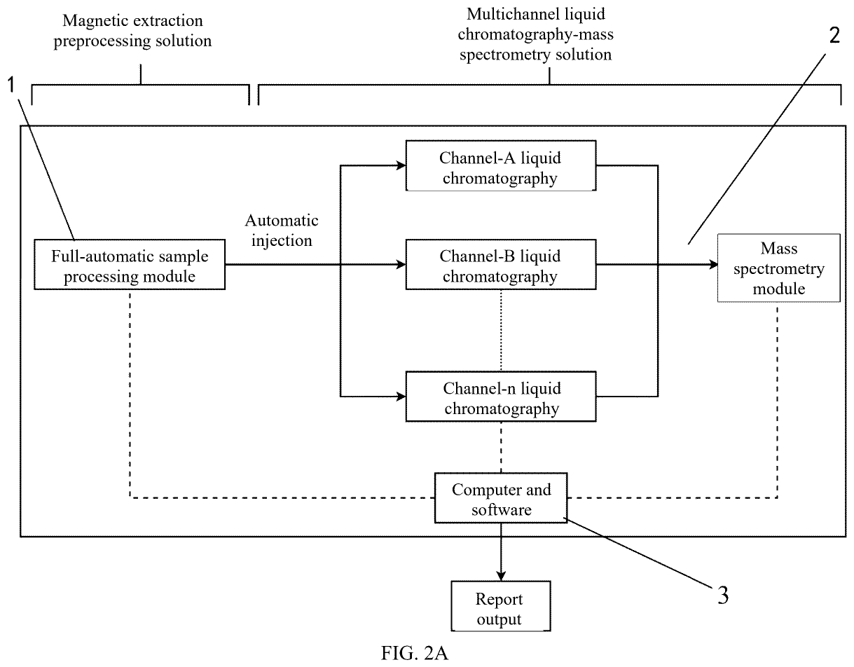

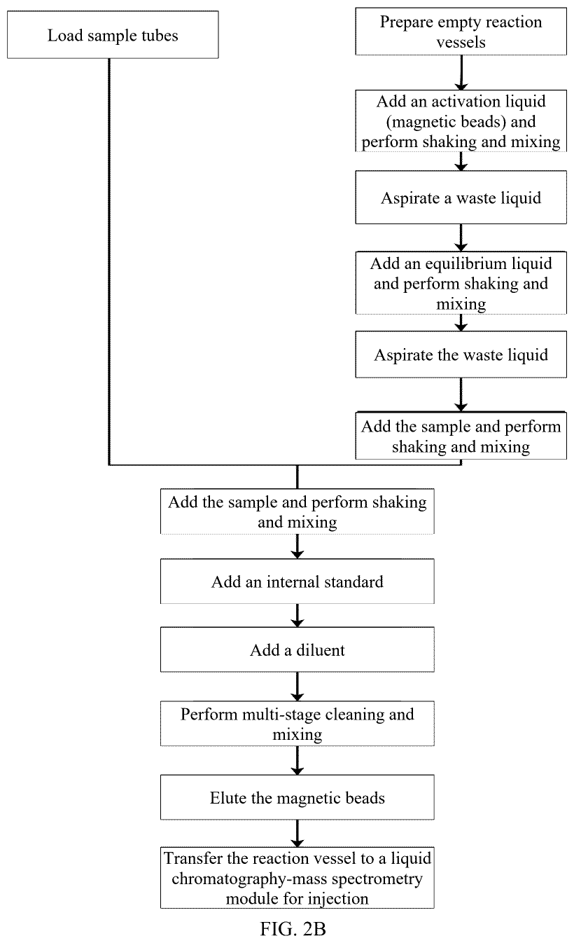

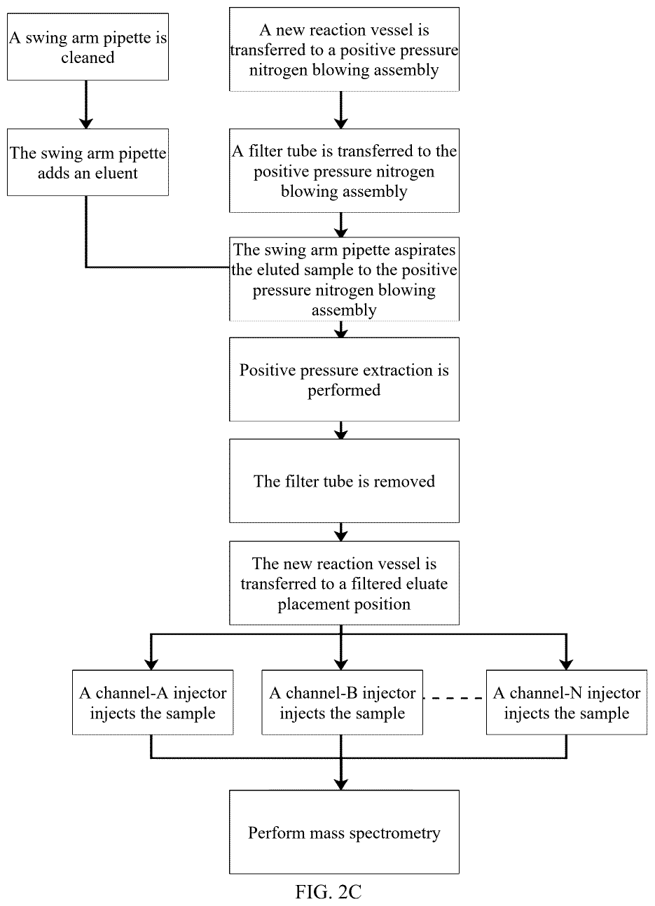

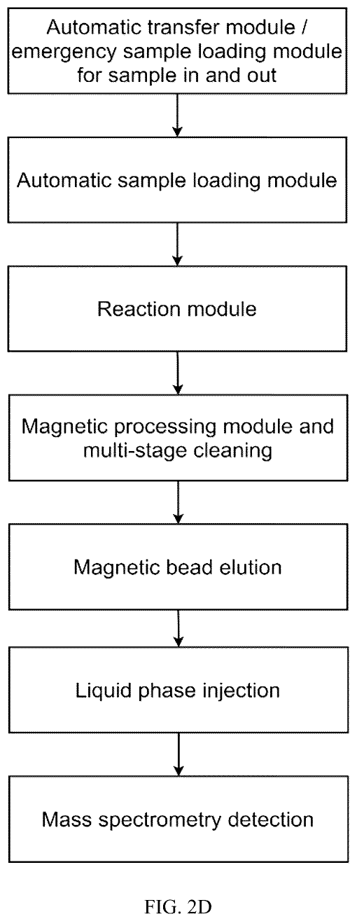

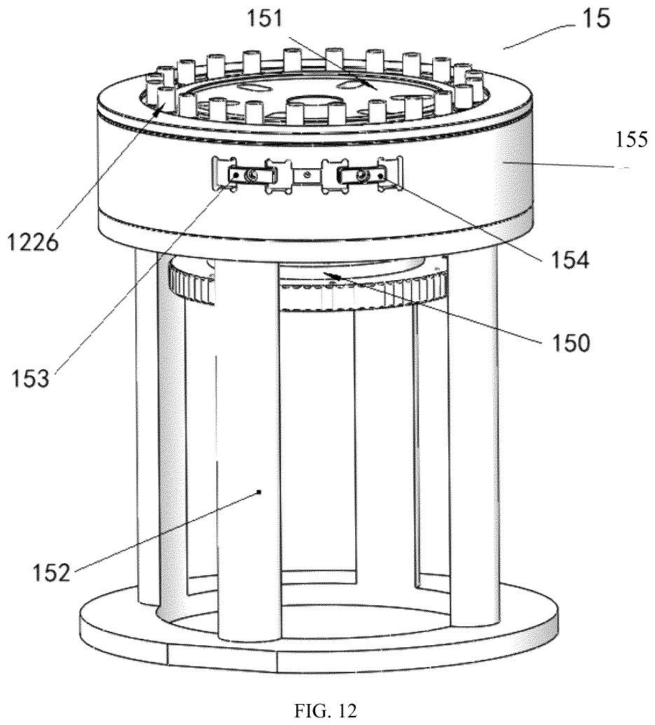

Therefore, the magnetic bead processing module can be realized by drawing the liquid in the reaction vessel and adding the liquid to the reaction repeatedly. For example, referring to the operating flow in FIG. 2B and referring to FIG. 12A to FIG. 13B, when the empty reaction vessel is transported to the reaction module by the manipulator, it is required to add the activation liquid, which contains the suspended magnetic bead, to the reaction vessel, then move the reaction vessel onto the reaction disk 151 through the manipulator and allow the multi-stage cleaning component to aspirate the activation liquid. Then, the equilibrium liquid may be added by the liquid adding needle of the multi-stage cleaning component, and the waste liquid is absorbed by the waste liquid aspirating needle. At this time, the manipulator transports the reaction vessel into the sample loading module for sample addition. After shaking of the added sample is completed, an internal standard, a diluent and other liquids may be added. Then, the reaction vessel is transported into the reaction module for the completion of the addition. Then, the reaction vessel is transported to the magnetic bead processing module, for example, to the reaction disk 151, and aspiration of the waste liquid and addition of the washing liquid are repeated. After repeated washing and repeated aspiration of the waste liquid are completed, the eluate is added. The eluate here is the liquid to be tested, which may contain the target analyte.

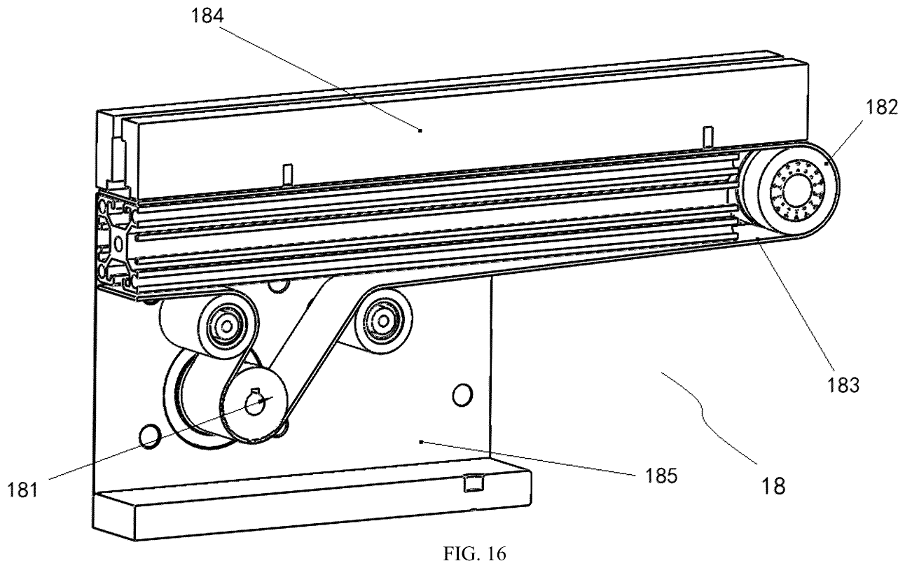

Therefore, in some embodiments, the reaction vessel with the eluate is transported by the manipulator into an eluate output structure, for example, a slot of the conveyor support shown in FIG. 16, and then is transmitted.

The eluate input conveyor line 18 is configured to transfer the cleaned reaction vessels (containing the compounds) to the multichannel liquid chromatography-mass spectrometry module 2. Specifically, the eluate (reaction vessels to be eluted) input conveyor line 18 includes an output conveyor motor, an output timing pulley 181, an output timing belt 182, a reaction vessel conveyor support 184 and an elution output line seat. The reaction vessel conveyor support 184 is arranged above the output timing belt 182.

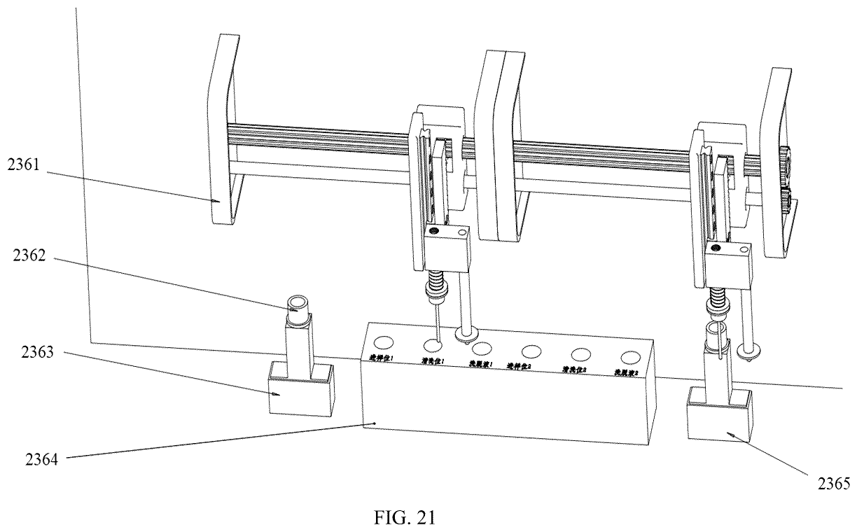

The reaction vessel conveyor support is capable of limiting the reaction vessels 1226 on the output timing belt 181, and the output conveyor motor drives the output timing belt to move through the output timing pulley 182 so as to transfer the reaction vessels 1226 on the reaction vessel conveyor support 184 to a next station (multichannel injection module), for example, to the station shown in FIG. 21 for eluate aspiration and filtration. After the eluate aspiration and filtration are completed, the eluate enters the multichannel liquid paths for liquid-phase separation, and then is subjected to mass spectrometry testing.

### Magnetic Beads

The magnetic beads used in the invention are micro (20 to 30 nm) iron oxide particles (also referred to as magnetic materials) developed based on a core-shell magnetic mesoporous silica composite, which are coated with a high-polymer material. By connecting different types of high-polymer materials to the surface of the magnetic mesoporous material, different compounds can be selectively extracted and separated from the biological sample. By using the magnetic material technique, the enrichment processes for different types of compounds can be unified in operation flow, thus providing a universal full-automatic work flow preprocessing solution.

The novel extraction material which combines the magnetic mesoporous composite with micro domains can be used in combination with molecular exclusion, van der Waals force, dipole interaction and ion exchange to directly separate target small molecule compounds with different binding characteristics from different types of biological samples, so as to better realize selective separation and extraction of target small molecules. The combination of the novel extraction material with a magnetic material automatic processing apparatus can eliminate the influence of flow rate and the risk of blockage in traditional SPE solid-phase extraction, avoid the problem of great differences between pores and between batches in SPE solid-phase extraction and accelerate the extraction process. Moreover, through the exclusion of mesopores, the biomacromolecule matrix in the liquid sample can be effectively separated and removed, leaving the contaminants in the solution, thereby effectively reducing the matrix effect during the mass spectrometry testing.

### Transport Module (Manipulator)

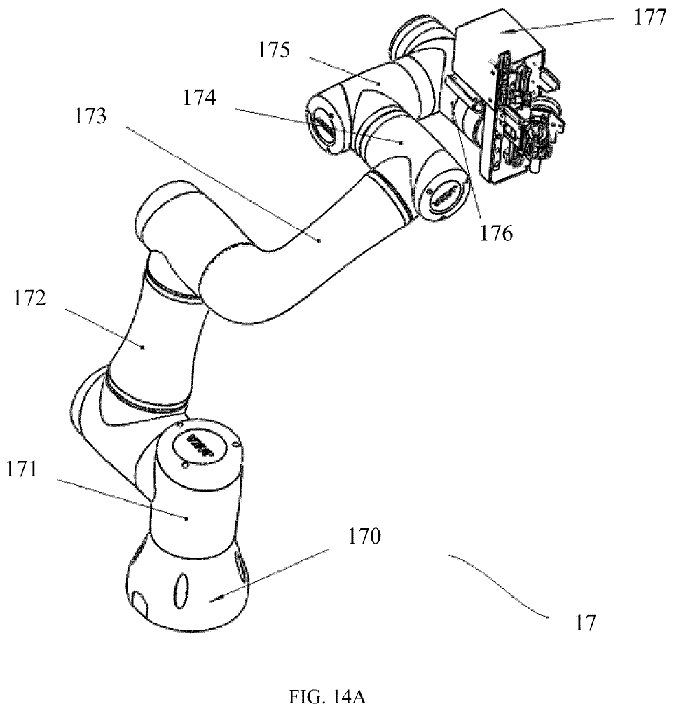

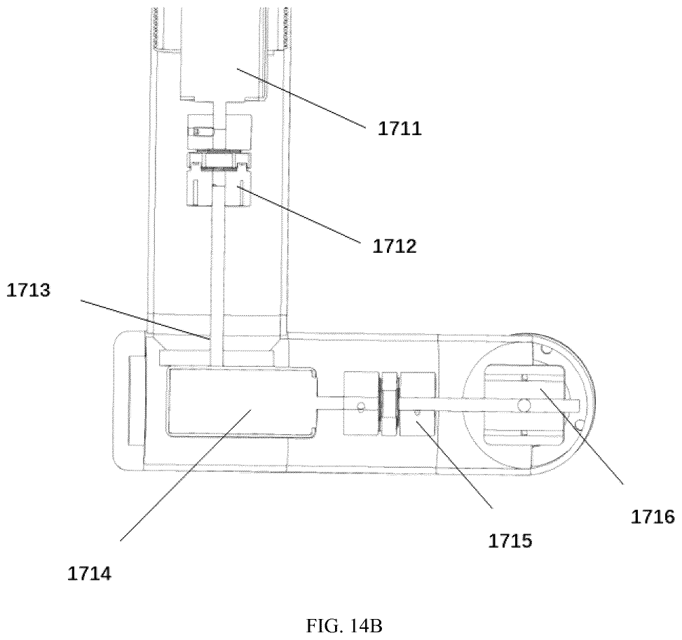

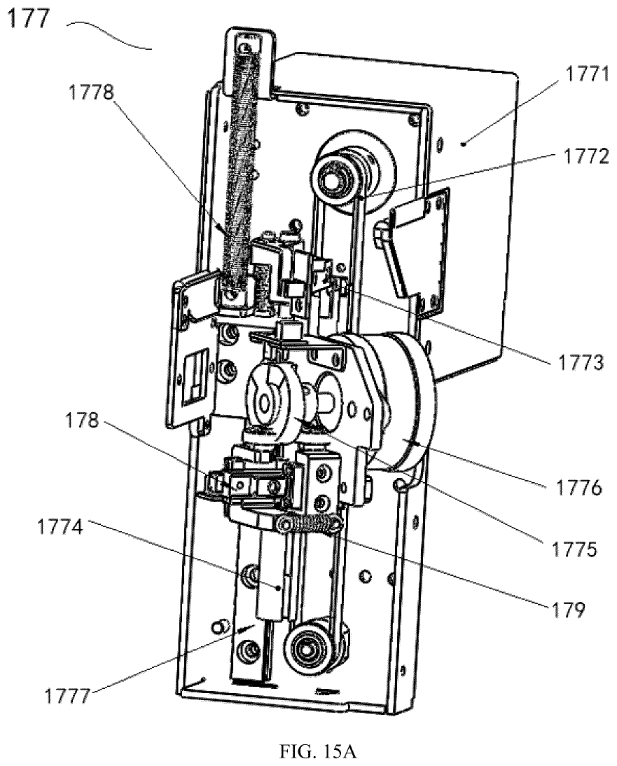

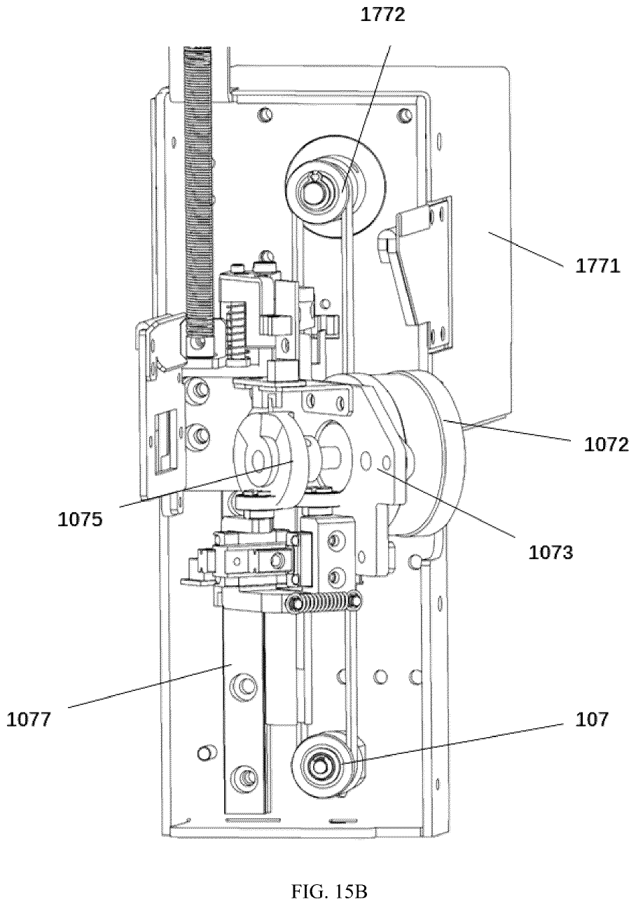

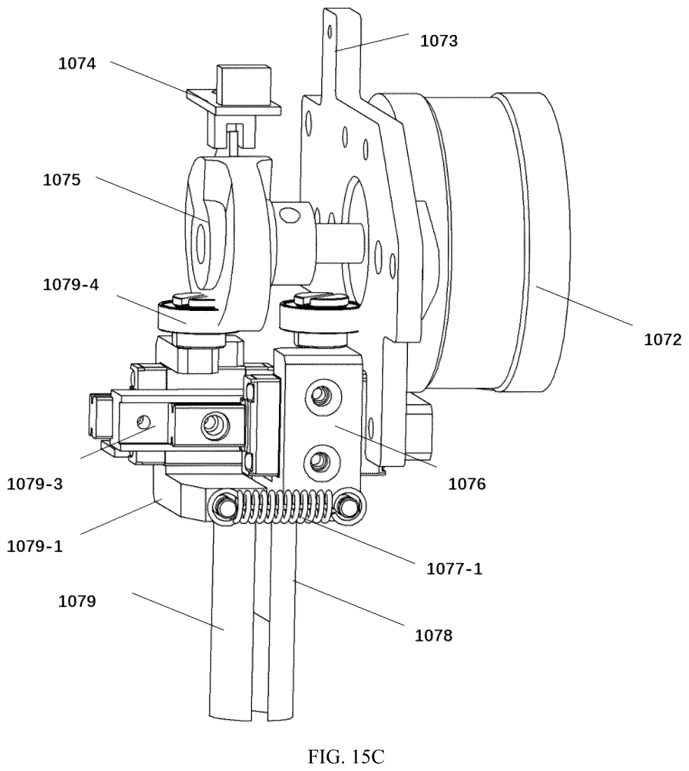

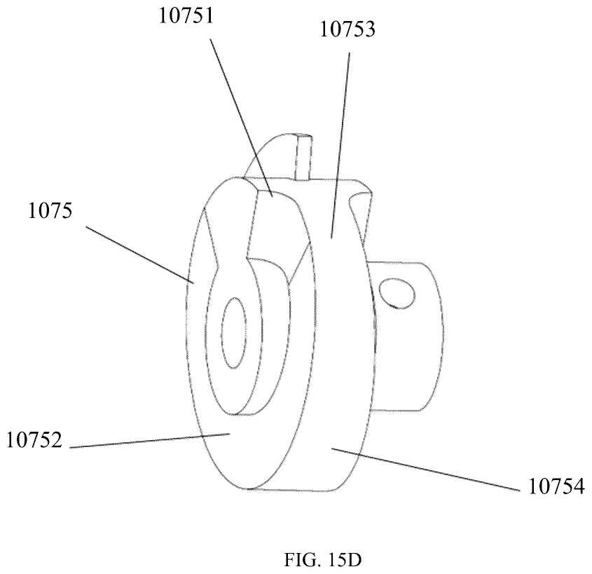

As shown in FIG. 14 to FIG. 15, the transport module 17 is configured to transfer, or pick up and release the reaction vessels among the modules. For example, the transport module may pick up an empty reaction vessel from the structure 144 in FIG. 11 to the shaking structure 131 of the reaction module for addition of the activation liquid, then pick up the reaction vessel from the structure 131 to the reaction disk 151 for magnetic bead processing, pick up the reaction vessel from the reaction disk 151 to the structure 1227 of the sample loading module for sample loading and shaking during the magnetic bead processing, then transport the reaction vessel into the structure 131 for addition of the diluent or other liquids, then transfer the reaction vessel to the reaction disk 151 again for aspiration of the waste liquid or to the multi-stage cleaning component for repeated washing and discharge of the waste liquid and addition of the eluate, and transfer the reaction vessel to the transmission structure through the manipulator for processing before liquid chromatography testing, such as filtration and purification, and sealing of the reaction vessel.

Specifically, the transport module 17 includes a manipulator, which includes a mounting base 170 mounted on a same base plate as the sample loading module, the reaction module and the magnetic bead processing module, and multiple levels of manipulator arms. The multiple levels of manipulator arms are mainly configured to control the transfer route and angle of the gripper component, and may include a first-level manipulator arm 171, a second-level manipulator arm 172, a third-level manipulator arm 173, a fourth-level manipulator arm 174, a fifth-level manipulator arm 175 and a sixth-level manipulator arm 176. Of course, in some embodiments, the number of the multiple levels of manipulator arms may be 2 or more. In some embodiments, the manipulator includes a (vessel pickup Z-direction) gripper component 177 for picking up the reaction vessels 1226, and the manipulator arms of all levels are rotatable relative to each other to realize multi-angle multi-range rotation. Of course, such manipulator arms can be arranged freely and can rotate relative to each other. In some embodiments, the rotation of the multiple levels of manipulator arms may be realized by well-known methods. For example, in some embodiments, two different arms are connected to realize angular rotation (as shown in FIG. 14B). For example, 171 is a 1st-level arm motor, 1712 is a coupling, 1713 is a lower 2nd-level arm connector, 1714 is a lower 2nd-level motor, 1715 is a lower 3rd-level coupling, and 1716 is a lower 3rd-level arm connector. The rotation of the motor 171 drives the first-level arm to rotate so as to realize one degree of freedom, and the multiple levels of manipulator arms have the same principle, thereby realizing the motion of multiple degrees of freedom.

As shown in FIG. 15, the vessel pickup Z-direction gripper component 177 includes a Z-axis motion motor 1771, a Z-axis timing belt 1772 and a motion connector 1773. The Z-axis motion motor 1771 drives the vessel pickup Z-direction gripper component 177 to move up and down through the Z-axis timing belt 1772 and the motion connector 1773. The vessel pickup Z-direction gripper component 177 further includes vessel pickup gripper jaws 1774 arranged in pair, the vessel pickup gripper jaws 1774 arranged in pair are respectively mounted on the vessel pickup slide rail component 178 oppositely and connected through a vessel pickup spring 179, and a vessel pickup curved wheel 1775 is arranged between upper ends of the two vessel pickup gripper jaws. The vessel pickup curved wheel 1775 has a varying thickness, thus forming a rotating wheel having a curved section. The vessel pickup curved wheel 1775 is rotatable when driven by a vessel pickup motor 1776. When a wider part of the vessel pickup curved wheel rotates to between the upper ends of the vessel pickup gripper jaws 1774, the vessel pickup gripper jaws 1774 are pushed open along the vessel pickup slide rail component 178, at this time, the vessel pickup gripper jaws are sleevable on an upper part of the reaction vessel 1226, and then, the vessel pickup curved wheel 1775 continues rotating until a narrow part rotates to between the upper ends of the vessel pickup gripper jaws 1775, thereby completing pickup. Auxiliary structures include a Z-axis motion slide rail component 1777 and an auxiliary spring 1778. The Z-axis motion slide rail component 1777 serves as a guide component for up-and-down sliding, and the auxiliary spring 1778 functions to support a weight and reduce a motor load. In addition, a vessel pickup limit sensor and a vessel pickup limit sensor chip are further provided to improve accuracy of vessel pickup.

More specifically, as shown in FIG. 15B to FIG. 15D, the motion motor 1771 drives the belt to rotate so as to drive the whole pickup component 1071 to move up and down, such that the reaction vessel moves up and down. Then, through the motion of the motor in the pickup component 1071, the pickup jaws 1774 are controlled to open and close so as to open and close the reaction vessel, such that the reaction vessel is fixed and released. Specifically, as shown in FIG. 15C, the motor 1072 drives a control sheet 1075 to rotate, and the two pickup jaws 1079, 1078 are openable and closable relative to each other and are respectively fixed to fixed seats 1079-1, 1079-2. The two fixed seats are connected through a spring 1077. The fixed seat 1079 is connected to a moving seat 1079-4 through a mechanical structure, and the moving seat is in movable contact with the control sheet 1075. The control sheet 1075 has a rotating surface. The rotating surface has two thicknesses, namely a low thickness 10751 and a high thickness 1075-2, and there is a gentle transition between the two thicknesses. When the control sheet rotates, the moving seat is in contact with the surface having two thicknesses. When the moving seat is at the surface with the low thickness, the jaws 1079, 1078 close due to the retraction of the spring. When the moving seat is in contact with the surface with the high thickness, the moving seat moves from inside to outside, and the jaws 1079, 1078 open due to the resistance of the spring. Through the rotation of the control sheet, the jaws can open and close, thereby realizing pickup and release or dropping of the reaction vessel.

### Cooperation and Position Mounting of Automatic Sample Feeding and Discharging Module, Sample Loading Module, Reaction Module, Magnetic Processing Module and Manipulator

Overall layout: Referring to FIG. 3, the automatic sample feeding and discharging module 11, the sample loading module 12, the reaction module 13, the manipulator 17, the magnetic processing module 16 and the reaction vessel loading mechanism 14 have a reasonable layout on the whole platform, which facilitates the operation flow of the whole sample and maximizes the use of space without affecting the preprocessing process of the sample. For example, on the platform, the automatic sample feeding and discharging module is arranged at one end of the platform, and the emergency sample loading is arranged at the tail of the sample feeding, which facilitates loading and unloading of the sample basket. The sample disk module and the reagent disk are arranged side by side. The sample disk module 116 is arranged near the pipette, and the pipette 12111 is arranged between the sample disk module and the sample shaking mechanism, which facilitates sample suction and sample application. Moreover, the sample shaking table 1227 is arranged on an outer side. This shaking table and the shaking table 131 of the reaction module are arranged at a same time. The two shaking tables 1227, 131 are both configured to place reaction vessels and arranged on the same side of the manipulator 17, so that the manipulator can transport the reaction vessels in sequence, and the length of the manipulator 17 is reduced. Similarly, the reaction vessel loading mechanism 14 is arranged beside the reaction module, so that the empty reaction vessels sorted by the reaction vessel loading mechanism can be transported onto the shaking table 131 for the addition of the activation liquid or the equilibrium liquid (adding the magnetic beads and preprocessing the magnetic beads before contacting the sample), which provides a space for the rotation of the manipulator 17. In addition, the magnetic processing module is arranged above manipulator 17, and the multi-stage cleaning component is arranged on the magnetic reaction disk, so that the manipulator 17 can transport the reaction vessels conveniently. Similarly, after the reaction vessels are subjected to magnetic processing and before magnetic beam elution, the reaction vessels need to be transported to the filtration before entering liquid chromatography, so the conveyor line 18 is arranged at the lower end of the magnetic processing module 16.

Therefore, the manipulator 17 is surrounded by the sample feeding and discharging module, the reaction module, the empty reaction vessel loading mechanism 14, the magnetic processing module 14 and the conveyor line 18, so that the manipulator can load and transport the reaction vessels conveniently, which realizes compact arrangement in a limited space, thereby reducing the waste of space and reducing the size of the whole system.

As can be seen from the above description, the automatic sample feeding and discharging module is responsible for transporting the test tubes with the sample baskets into the sample disk module 16. As the sample disk module rotates, the pipette of the sample loading module absorbs the sample from the test tube and adds the sample to the reaction vessel in the station on the shaking structure 122. Before the reaction vessel is transported onto the shaking structure 122, the activation liquid or the equilibrium liquid (the magnetic beads) may be added to the reaction vessel on the shaking structure 131 of the reaction module. The reaction module is configured to prepare the reaction vessels. After the preparation is finished, the sample loading module adds the sample (e.g., blood sample) to the reaction vessel for magnetic bead adsorption. When the sample is mixed with the magnetic beads, the internal standard is added, the magnetic beads are eluted to obtain the analyte, and then the eluate is subjected to subsequent liquid chromatography and mass spectrometry (as shown in FIG. 2D). Before the sample loading module, the sample tube containing the sample is automatically conveyed to wait for loading. The reaction module and the sample loading module may operate in parallel. Before the sample loading module completes loading, the reaction module is started, and after the reaction module completes operation, the sample loading module operates. Before the sample loading module operates, the automatic feeding and discharging module operates. In some embodiments, the automatic feeding and discharging module conveys the sample to the sample disk module to wait for loading through mechanical movements, and during the process of automatically conveying the sample tube or sample basket, the reaction module also operates. The reaction module is mainly configured to prepare the sample vessel and add the magnetic beads into the empty vessel. After the magnetic beads are loaded, the sample vessel with the magnetic beads is placed on the sample shaking and mixing module 122 of the sample loading module and subjected to sample application and shaking in this module. A detailed description will be made below with reference to the accompanying drawings.

The operation flow will be described with reference to the operation flows shown in FIG. 2A to FIG. 2D in combination with the system of the invention as a specific embodiment.

Referring to FIG. 2B, the automatic feeding and discharging module and the preparation of the empty reaction vessels may operate at the same time. For example, the sample basket is loaded in the sample disk module 16 for the preparation for sample application. Slightly before the preparation for sample application, the reaction vessel loading mechanism 14 may be started to load and sort the reaction vessels and allow the empty reaction vessels to be arranged in the reaction vessel transport tray 144 to wait for sampling or loading.

The transport module or manipulator 17 picks up the empty reaction vessel from the transport tray and then inserts or places the empty reaction vessel onto the shaking table 131 of the reaction module. Then the reagent aspirating needle 1373 draws the activation liquid containing the magnetic beads from the reagent disk 138 into the empty reaction vessel, and the reaction vessel is transported onto the magnetic bead disk to retain the magnetic beads and aspirate the waste liquid. Then, the equilibrium liquid may be added on the multi-stage cleaning component; or the reaction vessel with the magnetic beads may be transported by the manipulator 17 onto the shaking table 131, the equilibrium liquid may be added by the reagent aspirating needle 1373, and the reaction vessel is shaken. The reaction vessel with the equilibrium liquid is transported onto the magnetic bead disk of the magnetic bead processing module to aspirate the waste liquid. After the aspiration of the waste liquid is completed, the reaction vessel with the magnetic beads is directly transported onto the shaking table 122 of the sample loading module by the manipulator for the addition of the sample. The sample is added to the reaction vessel through the pipette, and the reaction vessel is shaken, such that the sample can thoroughly contact the magnetic beads.

Then, the reaction vessel with the liquid sample and the magnetic beads may be transported onto the shaking table 131 of the reaction module by the manipulator 17 for the addition of the internal standard or the diluent. Then, the reaction vessel is transported by the manipulator to the magnetic reaction disk of the magnetic bead processing module for the aspiration of the waste liquid, and the magnetic beads are cleaned through multi-stage cleaning (the cleaning here is to remove impurities without separating the analyte from the magnetic beads). After cleaning and removal of the cleaning liquid are repeated many times, the analyte is eluted from the magnetic beads, and then the manipulator picks up the empty reaction vessel onto the transport module 18. Then, the manipulator transports the reaction vessel with the magnetic beads onto the transport module 18 for the transmission of the reaction vessel. Finally, the reaction vessel is transferred from the reaction disk component 15 to the eluate input conveyor line 18.

In some embodiments, the specific flow of sample preprocessing in the preprocessing module of the invention includes:
1) the sample loading module adds the activation liquid (containing the magnetic beads which are matched with the compound) to the reaction vessel 1289, and the sample shaking and mixing module performs shaking and mixing at a speed of not less than 100 rpm for not less than 1 min;
2) the magnetic beads are adsorbed on the magnetic reaction disk, and the waste liquid is removed;
3) the sample loading module adds the equilibrium liquid to the reaction vessel, and shaking and mixing are performed at a speed of not less than 100 rpm for not less than 1 min;
4) the magnetic beads are adsorbed on the magnetic reaction disk, and the waste liquid is removed;
5) the pipetting module absorbs the sample from the sample tube into the reaction vessel, the sample loading module aspirates the internal standard into the reaction vessel, and shaking and mixing are performed at a speed of not less than 100 rpm for not less than 1 min;
6) the magnetic beads are adsorbed on the magnetic reaction disk, and the waste liquid is removed;
7) the multi-stage cleaning component adds the cleaning liquid to the reaction vessel, and shaking and mixing are performed at a speed of not less than 100 rpm for not less than 1 min;
8) the magnetic beads are adsorbed by the magnetic module on the magnetic reaction disk, and the waste liquid is removed;
9) step 7 to step 8 are repeated more than one time (depending on the sample and the compound, if necessary);
10) the magnetic beam eluate is added to the reaction vessel, and shaking and mixing are performed at a speed of not less than 100 rpm for not less than 1 min, to obtain a solution containing the analyte;
11) by positive pressure filtration, the sample in the reaction vessel is passed through a filter tube and filtered by a filter membrane, and the filtered sample is transferred into a new reaction vessel;
12) the diluent is added to the new reaction vessel, and shaking and mixing are performed at a speed of not less than 100 rpm for not less than 1 min; and
13) the new reaction vessel is transferred to one channel in the multichannel liquid chromatography-mass spectrometry module, thereby completing sample injection.

### Processing Before Sample Loading of Liquid Chromatography

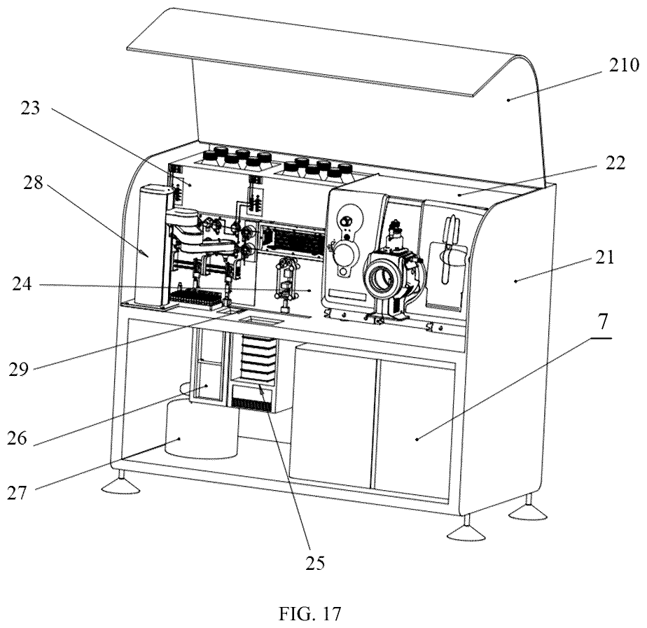

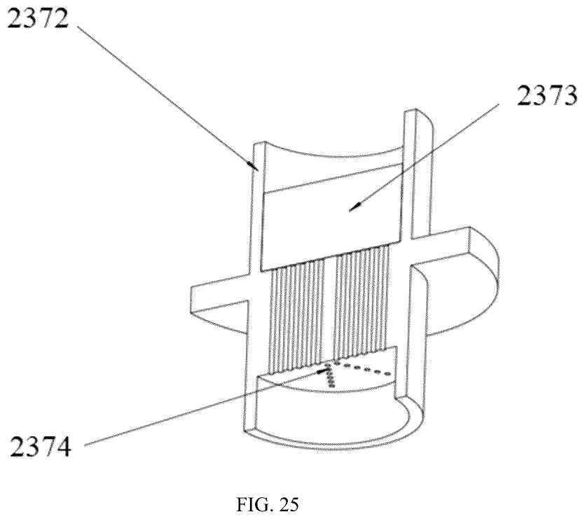

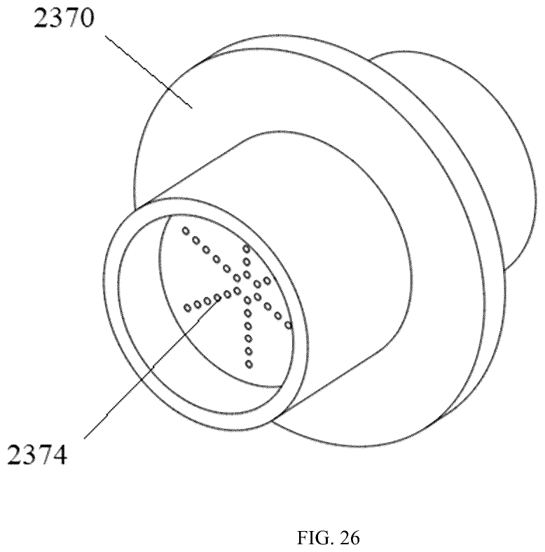

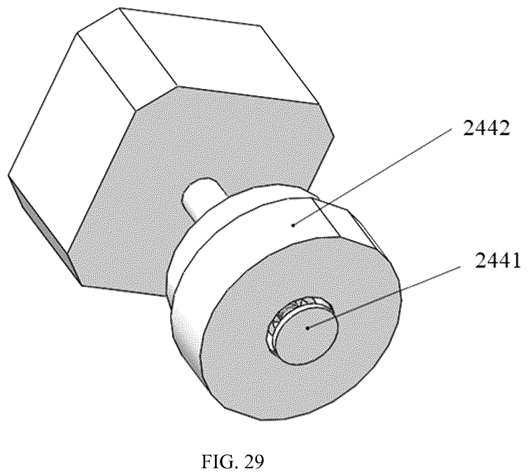

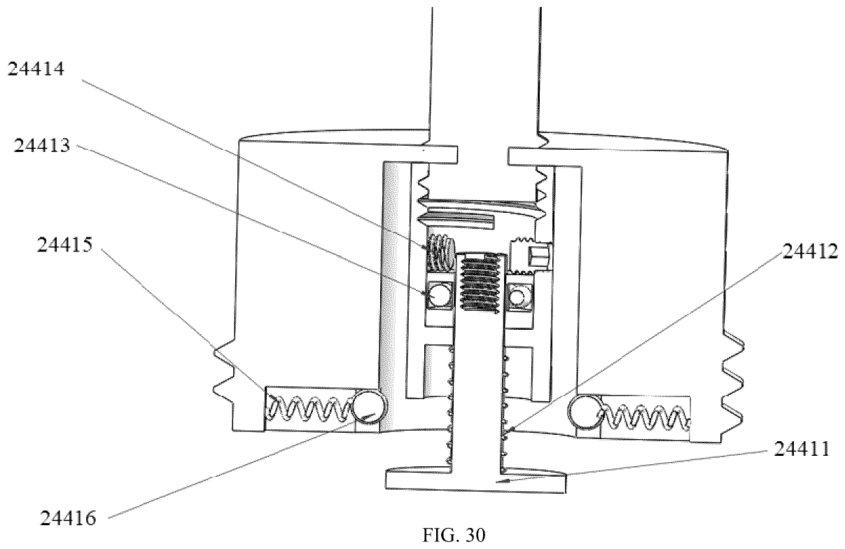

For the implementation, reference may be made to FIG. 17 to FIG. 31.

This embodiment provides a multichannel liquid chromatography-mass spectrometry module 2 which can be used in Embodiment 1 and/or Embodiment 2. As shown in FIG. 17, the multichannel liquid chromatography-mass spectrometry module 2 includes a frame 21, and a triple quadrupole mass spectrometry module 22, a multichannel injection and separation module 23, a film sealing module 24, a constant-temperature storage chamber 25, a waste collection chamber 26, a waste liquid barrel 27, a mechanical vacuum pump and nitrogen generator module 28 and a sample assembly line 29 are arranged in the frame 21. The frame 21 is provided with an observation window 210. In this embodiment, the observation window 210 is rotatably mounted on the frame 21 and can be closed. Preferably, the observation window 210 may be made of a transparent material. After the observation window is closed, the inside of the multichannel liquid chromatography-mass spectrometry module can be observed, and dust can be prevented from entry.

The triple quadrupole mass spectrometry module 22 is configured to complete data acquisition and establish communication with the computer module 3. The multichannel injection and separation module 23 realizes double-channel injection and completes double-channel cooperative injection, and has the functions of double-channel mobile phase driving, magnetic bead separation, sample aspiration, needle cleaning, compound separation and channel switching. The film sealing module 24 completes film sealing of the reaction vessels after injection. The constant-temperature storage chamber 25 is configured to store the reaction vessels that have completed film sealing, so that the reaction vessels can be taken out for re-injection when abnormalities occur. The waste collection chamber 26 is configured to store the waste liquid, waste reaction vessels and other wastes. The waste liquid barrel 27 is arranged below the waste collection chamber 26 and configured to temporarily store the waste liquid and other wastes collected by the waste collection chamber 26. The waste liquid barrel 27 may be taken out and dumped. In the mechanical vacuum pump and nitrogen generator module 28, a mechanical vacuum pump is a backing pump of the triple quadrupole mass spectrometry module and cooperates with the triple quadrupole mass spectrometry module to complete vacuum suction together. The sample assembly line 29 is configured to place the cleaned reaction vessels from the full-automatic sample processing module and transmit the cleaned reaction vessels to docking positions of the multichannel injection and separation module 23, the film sealing module 24 and the constant-temperature storage chamber 25.

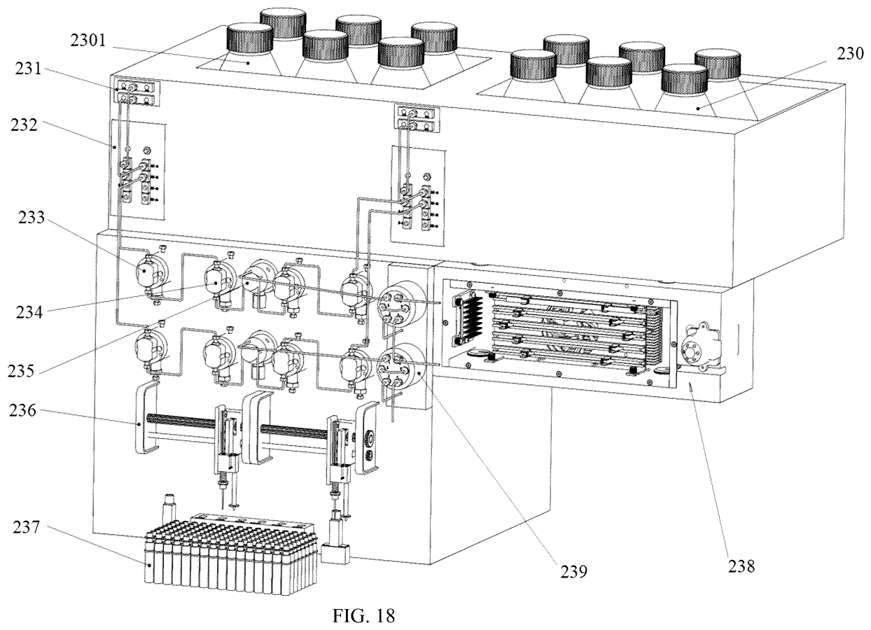

Specifically, as shown in FIG. 18, the multichannel injection and separation module 23 includes a reagent bottle placement area 230. The reagent bottle placement area 230 may contain a plurality of reagent bottles 2301 therein. A solvent proportioning valve 231, a degasser module 232, a primary liquid-phase pump 233, a secondary liquid-phase pump 234 and a mixer 235 are sequentially arranged outside the reagent bottle placement area 230 along a flow direction (forward direction/reverse direction) of the reagents. A lower part of the multichannel injection and separation module 23 is provided with an injection assembly 236. The injection assembly 236 aspirates a liquid sample from an injection sample reaction vessel 237. The multichannel injection and separation module 23 further includes a column switching and separation module 238. In this embodiment, the reagent bottle placement area 230 includes two blocks, and both of the two blocks can be used for placing reagent bottles. The reagent bottles may be connected to injection channels through passages arranged in the blocks. The reagent bottle placement area 230 can support a total of 8 passages of reagents, and allow free combinations of the 8 passages of reagents (through the injection channels and valves in the module).

The solvent proportioning valve 231 may adjust a proportion of solvents injected according to needs and a set proportion (through a valve disk arranged). The degasser module 232 is configured to bubbles in reagent tubes (injection channels), which makes the pressure more stable and the flow rate more accurate. The primary liquid-phase pump 233 and the secondary liquid-phase pump 234 are configured to drive the reagents to flow, which ensures smooth sample injection. The mixer 235 is configured to mix reagents of different mobile phases efficiently and uniformly, which helps in improving the injection consistency. The injection assembly 236 includes at least two injection modules 2360. Each injection module 2360 may independently implement magnetic bead separation by nitrogen blowing, syringe sample aspiration and cleaning. The multichannel injection and separation module further includes six-way injection valves 239. The six-way injection valves 239 are connected to the mixer 235, the syringe of the injection assembly 236, and the separation module 23, and deliver the sample into the column switching and separation module 238 to prepare for compound separation. The separation module includes a preheating module, a temperature field adjusting module and a channel switching module.

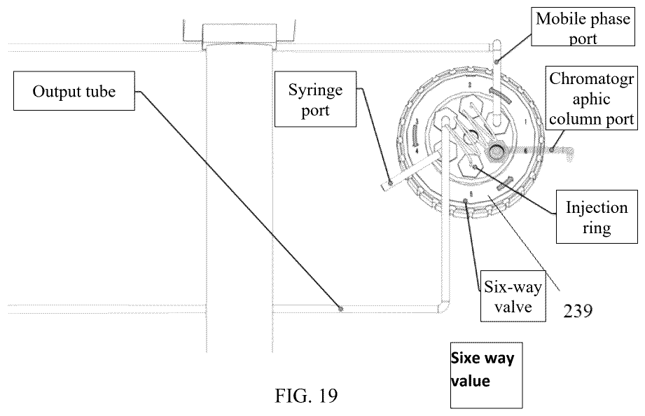

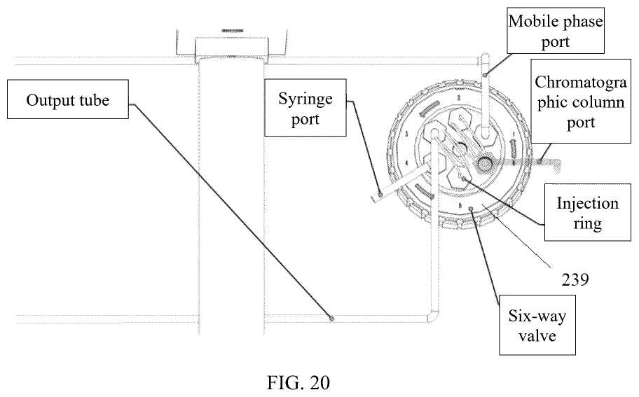

As shown in FIG. 19 to FIG. 20, each six-way injection valve 239 includes 6 channels which are divided into 3 groups, and every two channels are in communication with each other. Port 1 is a mobile phase port connected to the mixer 235, Port 2 is in communication with Port 5, Port 3 is connected to an output tube (connected to a piston), Port 4 is a syringe port connected to the syringe of the injection assembly 236, Port 5 is connected to an injection ring, and Port 6 is connected to the chromatographic column. State switching is realized by counterclockwise rotation as shown in the figure. The six-way injection valve 239 has a position state A and a position state B. During switching, the communication channel is switched to the adjacent channel (for example, in the position state A, Port 1 is in communication with Port 2, and in the position state B, Port 1 is in communication with Port 6). The position state A is the injection mode (FIG. 19), and the position state B is the equilibrium mode (FIG. 20). Through the six-way injection valve 239, double-channel injection can be realized. The specific working principle is as follows: As shown in FIG. 2, when one of the six-way injection valves 239 is in the position state B, the syringe of the injection assembly completes magnetic bead removal, syringe cleaning and sample absorption, so that the sample enters Port 5 through Port 4 connected to the syringe and is sucked into the injection ring of the six-way valve. After the other six-way injection valve completes injection, it is immediately switched to the injection mode in the position state A. In this way, the two six-way valves are switched like this to cooperate with the triple quadrupole mass spectrometer so as to complete the high-throughput injection, thereby avoiding the waste of resources (when one channel is matched with 1 mass spectrometry module, after the mass spectrometry module completes data acquisition of one sample, the next data acquisition cannot be started before the liquid chromatography completes equilibrium, cleaning and injection).

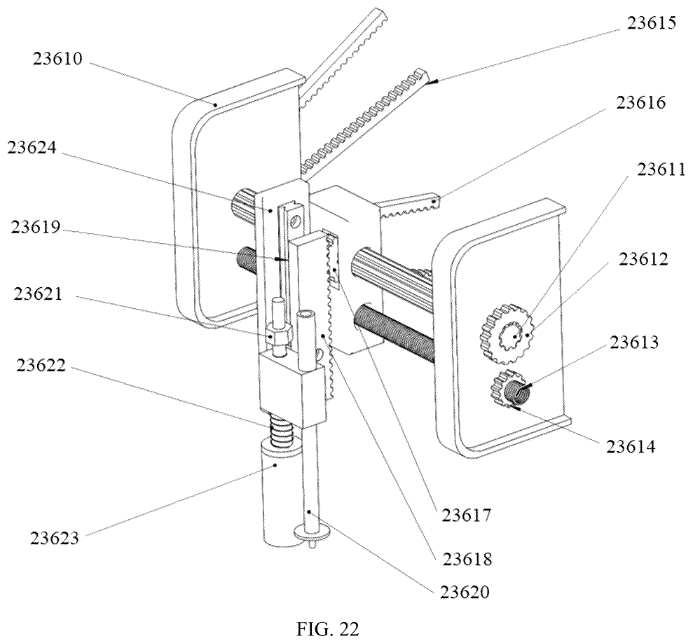

As shown in FIG. 21 to FIG. 22, each injection module 2360 in the injection assembly 236 includes a syringe kit 2361, a first channel reaction vessel 2362, a reaction vessel fixing seat 2363, a sample processing table 2364 and a second channel reaction vessel 2365. The sample processing table 2364 contains 2 sets of operation positions: injection position, cleaning position and eluent position. The injection position is configured to place the injection sample reaction vessel (the flexible claw cooperation module picks up the injection sample reaction vessel to this position) to wait for magnetic bead filtration. The cleaning position is configured to store the cleaning solvents, such as methanol and isopropanol. The eluent position is configured to store the magnetic bead eluting solvent, which is selected according to the specific type of the magnetic beads.

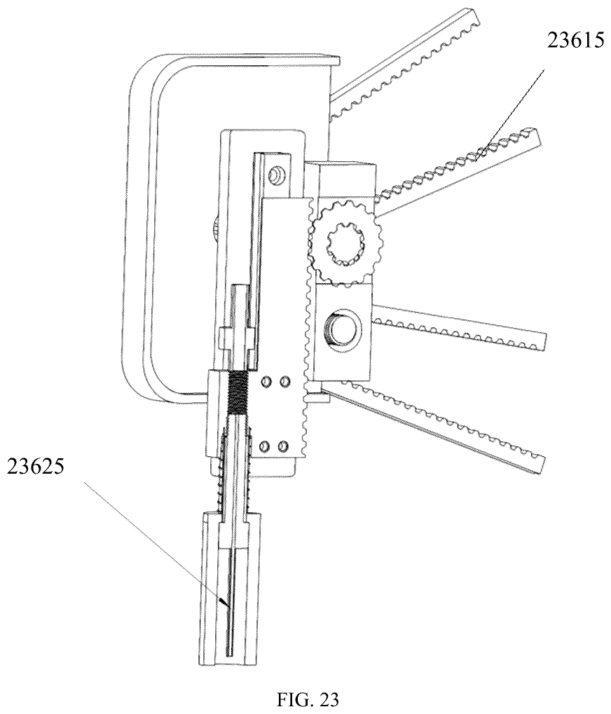

The syringe kit 2361 includes a fixed seat 23610, a Z-axis gear 23611, a Z-axis timing pulley 23612, an X-axis lead screw 23613, an X-axis timing pulley 23614, a Z-axis driving timing belt 23615, an X-axis driving timing belt 23616, a Z-axis transmission gear 23617, a Z-axis connecting slider 23618, a Z-axis slide rail component 23619, a nitrogen blower 23620, an injection tube 23621, a spring 23622, a reaction vessel pressing tube 23623, a syringe holder 23624 and a pipette 236 25. The Z-axis timing pulley 23612 drives the Z-axis gear 23611 to rotate through the Z-axis driving timing belt 23615, and the rotation is transmitted to the Z-axis connecting slider 23618 through the Z-axis transmission gear 23617 such that the Z-axis connecting slider 23618 moves up and down. The Z-axis connecting slider 23618 is fixed on the Z-axis slide rail component 23619. The X-axis driving timing belt 23616 drives the X-axis timing pulley 23614 and the X-axis lead screw 23613 to rotate, so that the syringe holder 23624 moves left and right along the X-axis direction. The nitrogen blower 23620 is connected to a nitrogen source. The nitrogen blower 23620 is pressed against the reaction vessel, the nitrogen source is opened to realize a positive pressure, and a filter assembly is used in combination to complete filtration of the magnetic beads. Each channel is matched with 1 syringe kit to complete filtration of the magnetic beads and aspiration of the sample. As shown in FIG. 23, when the solvent needs to be aspirated, the reaction vessel pressing tube is pressed against the reaction vessel or the sample processing table, the spring 23622 is compressed by force, the pipette inside extends out, aspirates the solvent and moves up upon completion, the spring 23622 returns to its original state, and the injection tube 23621 is connected to Port 4 of the six-way valve.

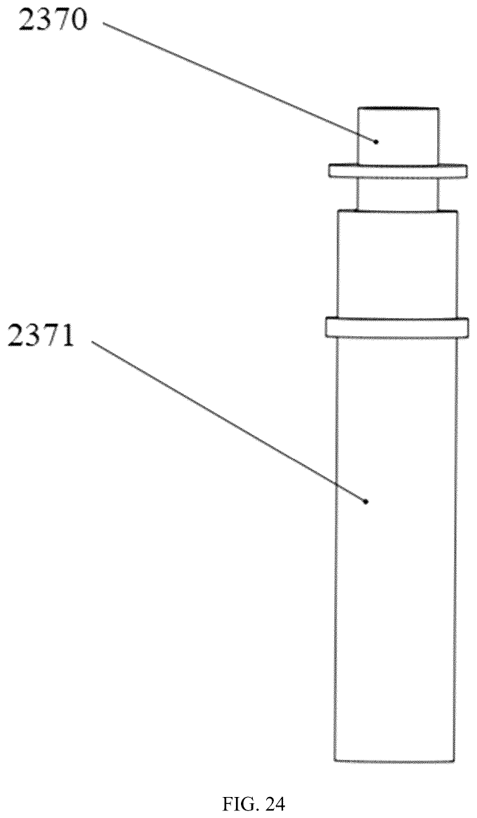

As shown in FIG. 24 to FIG. 26, the injection sample reaction vessel 237 includes a magnetic bead filter module 2370 and a reaction vessel 2371. The magnetic bead filter module 2370 is arranged on the reaction vessel 2371. The magnetic bead filter module 2370 includes a filter seat 2372 and a filter layer 2373. The filter seat 2372 contains filter holes 2374 therein. The injection sample reaction vessel 237 is configured to load the sample (magnetic removal) solvent, provided with a filter module 2370, which is preferably made of PES (hydrophilic polyethersulfone), which is not limited thereto and may be replaced according to the need of the compound. The pore size is 1 nm-30 nm, which is selected according to needs.

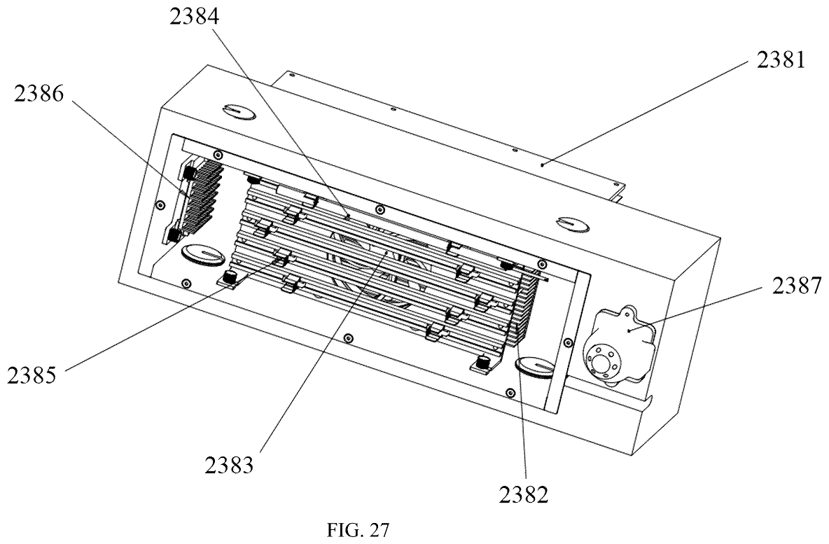

As shown in FIG. 27, the column switching and separation module 238 includes an external radiator 2381, an internal radiator 2382, an internal fan 2383, a temperature sensor 2384, chromatographic column clamps 2385, a preheating module 2386 and a column switching valve 2387. The chromatographic column clamps 2385 are configured to fix double-channel chromatographic columns. The chromatographic column is selected according to the type of the compound. An output tube from Port 6 of the six-way valve passes through radiating fins of the preheating module 2386 before entering the chromatographic column. A thermoelectric cooler is mounted between the external radiator 2381 and the internal radiator 2382 to realize temperature control. The internal fan improves the control efficiency. The temperature sensor 2384 is configured to detect a temperature. The column switching valve 2387 is connected to both of the two chromatographic columns to realize time-sharing injection.

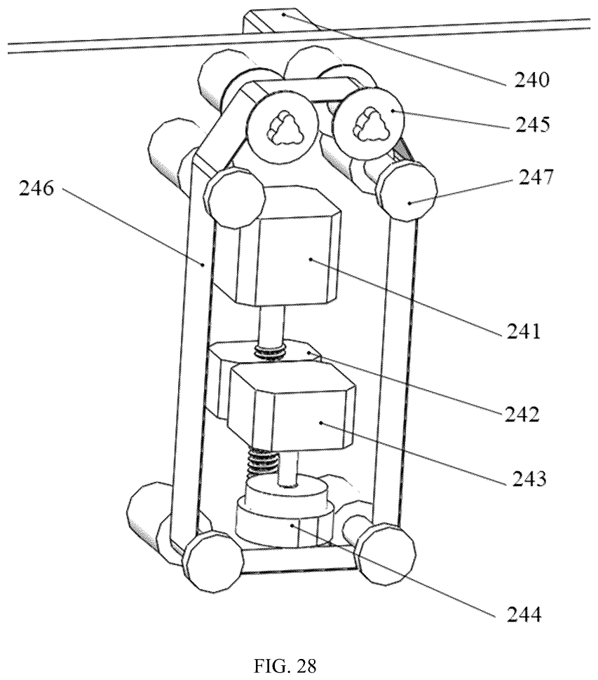

As shown in FIG. 28, the film sealing module 24 includes a film covering motor 240, a lifting motor 241, a lifting slider 242, a rotating motor 243, a film covering module 244, a film kit 245, a film 246 and guide wheels 247. The film covering motor 240 drives the film kit 245 and the film 246 to roll under the guide of the guide wheels 247. The lifting motor 241 and the lifting slider 242 drive the rotating motor 243 and the film covering module 244 to move up and down, so that the film covering module 244 can contact the reaction vessel that has completed sampling. The film covering module 244 includes a film covering head 2441 and an outer cover 2442. The film covering head 2441 includes a pressing plate 24411, a pressing plate spring 24412, a bearing 24413, a jack screw 24414, side pressing springs 24415 and side pressing steel balls 24416. When the film covering module 244 moves down, the pressing plate 24411 is configured to fix the reaction vessel, the pressing plate spring 24412 is compressed and pressed against an upper surface of the reaction vessel through the covering film, the reaction vessel extends deep inside, the side pressing springs 24415 also retract, the side pressing steel balls 24416 press against the covering film on the side of the reaction vessel, the rotating motor 243 rotates a number of turns, and the side of the reaction vessel is sealed.

The specific flow of testing a sample in the multichannel liquid chromatography-mass spectrometry module of the invention includes:
1) the syringe is cleaned with a strong cleaning liquid and a weak cleaning liquid (the cleaning liquids are selected according to the type of the sample and the type of the compound, and conventionally, the mobile phase A is an aqueous phase-containing solution and the mobile phase B is an organic phase solution);
2) the syringe aspirates a first sample (the amount of the sample aspirated is 1-100 μL) and injects the first sample into the switching valve of one channel;
3) the switching valve is switched to an injection position, and injection is started (the flow rate is 0.2-1.5 mL/min);
the sample is sequentially connected to the chromatographic column (the chromatographic column is in a column oven module, and the column oven temperature is 5-85° C.);
4) the chromatographic column switching valve is switched to mass spectrometry, and the sample is collected;
5) the syringe is cleaned with the strong cleaning liquid and the weak cleaning liquid;
6) the syringe aspirates a second sample (the amount of the sample aspirated is 1-100 μL) and injects the second sample into the switching valve of the other channel; and
7) the switching valve of the other channel is switched to an injection position, and injection is started.

At this time, the injection and collection of the first sample have not been completed, the sample of this channel is connected to the other chromatographic column, this chromatographic column is connected to another inlet port of the chromatographic column switching valve and in communication with a waste liquid output port, and after peak appearance of the first sample is completed, the injection of the second sample is immediately started. By rapidly switching between different channels, the high-throughput sample injection is completed, thereby greatly improving the efficiency.

Although the specification has recorded the preferred embodiments of the invention, those skilled in the art may make additional changes and modifications to these embodiments or combinations of embodiments without creative work once they know the basic creative concepts. Therefore, the scope of protection of the invention should be understood as the scope intended to be interpreted and covered by the claims, and should not be limited to the contents as detailed in the specification and embodiments of the invention. Moreover, the contents recorded in the invention, including the preferred embodiments, include all changes and modifications falling within the scope of the invention.

1. An LC-MS/MS test system, comprising: a full-automatic sample preprocessing module; wherein the full-automatic sample preprocessing module comprises an automatic sample feeding and discharging module for transporting sample baskets to be tested, and the automatic sample feeding and discharging module comprises a routine sample feeding and discharging structure and an emergency sample feeding and discharging structure, wherein the sample baskets to be tested comprise routine sample baskets and an emergency sample basket.

2. The system according to claim 1, wherein the automatic sample feeding and discharging module further comprises a transfer module for sample in and out, wherein the transfer module for sample in and out is located at tail ends of a routine sample feeding module and a sample exit module and is capable of pushing a routine sample basket to be tested at a tail end into a sample disk module, the sample disk module is located at one side of the sample exit module and provided with a sample basket entrance and exit, and sample basket slots for loading the sample baskets to be tested and tested sample baskets are arranged in the sample disk module at equal intervals.

3. The system according to claim 2, wherein the emergency sample basket is arranged at one end of the transfer module for sample in and out and configured to be capable of sample loading in priority, wherein temporary small-batch sample tubes are loaded in the emergency sample basket, moved to the front of a sample loading queue and rotated by the sample disk module to a sample loading position for priority processing.

4. The system according to claim 3, wherein the full-automatic sample preprocessing module further comprises a sample loading module for sucking samples into reaction vessels, the sample loading module comprises a pipetting module, a sample shaking and mixing module and a sample cleaning pool module for cleaning a pipette, and the pipetting module comprises a pipette module, a slide rail assembly, a translation sensor module, a translation motor and a cable carrier.

5. The system according to claim 4, wherein the pipette module comprises the pipette, a pipette up-and-down movement motor, a pipette movement timing belt, a pipette zeroing sensor, a pipette zeroing baffle, a pipette slide rail assembly, a pipette pipetting motor, an auxiliary spring, a pipetting action sensor and a pipetting action zeroing baffle; and the pipette up-and-down movement motor drives the pipette to move up and down through the pipette movement timing belt, the pipette slide rail assembly guides the pipette to move up and down, the pipette pipetting motor drives the pipetting action zeroing baffle to move up and down, the pipetting action sensor is configured to detect a position of the pipetting action zeroing baffle, and when the pipette zeroing sensor, serving as a limit position sensor, detects the pipette zeroing baffle, it is determined that the pipette is at a zero position in an up-down direction.

6. The system according to claim 5, wherein the pipetting module further comprises a limit baffle and a limit sensor, and when the limit sensor detects the limit baffle, transmission is stopped, and it is determined that the pipette is at a zero position in a left-right direction.

7. The system according to claim 5, wherein the pipetting module further comprises the translation motor, the slide rail assembly and the translation sensor module, the translation motor is configured to drive the pipette module to translate, the slide rail assembly is configured to guide the pipette module to translate, the translation sensor module is arranged at one end of the slide rail assembly and configured to accurately detect a translation position and feed back a signal, and the cable carrier is configured to protect communication and power cables of the pipette module and allow the cables to move together with the pipette module.

8. The system according to claim 4, wherein the sample shaking and mixing module comprises a sample shaking motor, a sample shaking motor coupling, a sample shaking timing belt, a sample shaking driving pulley, a rotational speed sensor, a sensor baffle, reaction vessels, a reaction vessel carrier, a driven shaft coupling, a sample shaking driven pulley and a sample mixing cleaning seat; and the sample shaking motor drives the reaction vessel carrier to perform shaking and mixing through the sample shaking motor coupling, the sample shaking timing belt and the sample shaking driving pulley, so that the reaction vessels with the samples are subjected to shaking and mixing.

9. The system according to claim 4, wherein the full-automatic sample processing module further comprises a reaction module for adding reagents into the reaction vessels, and the reaction module comprises a reaction cleaning pool module, a reaction vessel carrier, a reaction shaker, a reagent aspirating needle lifting motor, a reagent aspirating needle lifting transmission component, a reagent aspirating needle lifting rod support, a reagent aspirating needle rotating motor component, a reagent aspirating needle rotating motor zeroing sensor, a reagent aspirating needle rotating motor position sensor, a reagent aspirating needle component, reagent vessels, a reagent turntable motor and reagent turntable position sensors.

10. The system according to claim 9, wherein the reaction vessel carrier has sockets, blank reaction vessels are arranged in the sockets of the reaction vessel carrier according to certain rules, reagents in the reagent vessels are added to the reaction vessels through the reagent aspirating needles, the reagent aspirating needle lifting motor drives the reagent aspirating needles to rise and fall, the reagent turntable motor drives the reaction vessel carrier to rotate to facilitate reagent selection, and the reagent aspirating needle rotating motor component drives the reagent aspirating needle component to rotate.

11. The system according to claim 9, wherein the reaction cleaning pool module contains a cleaning agent and is configured to clean the reagent aspirating needles, and after the reagent is added to the reaction vessel, the reaction shaker performs shaking and mixing on the cleaning agent.

12. The system according to claim 11, wherein the full-automatic sample processing module further comprises a reaction vessel loading mechanism, the reaction vessel loading mechanism comprises a bulk compartment, a roll-on roll-off motor, a roll-on roll-off conveyor belt, a pre-loading channel, a reaction vessel transport tray and a reaction vessel transport tray motor, the roll-on roll-off motor is configured to drive the roll-on roll-off conveyor belt to move, the pre-loading channel is arranged at one side of an upper part of the roll-on roll-off conveyor belt and is in communication with the roll-on roll-off conveyor belt, the bulk compartment is arranged at a starting end of the roll-on roll-off conveyor belt, and the roll-on roll-off conveyor belt is provided with roll-on roll-off partitions; and when the roll-on roll-off conveyor belt is started, disorderly reaction vessels in the bulk compartment enter gaps between the roll-on roll-off partitions one by one so as to orderly enter the pre-loading channel through the roll-on roll-off conveyor belt and then are pushed into the reaction vessel transport tray one by one through the pre-loading channel, and the reaction vessel transport tray rotates the obtained reaction vessels to an outer side such that the reaction vessels are ready to be picked up.

13. The system according to claim 12, wherein the full-automatic sample processing module further comprises a magnetic processing module for processing reaction vessels with magnetic beads, the magnetic processing module comprises a magnetic reaction disk motor, a magnetic reaction disk and a reaction disk base, the magnetic reaction disk is arranged on the reaction disk base, the magnetic reaction disk motor drives the magnetic reaction disk to rotate, an outer wall of the magnetic reaction disk is provided with a magnetic module, the magnetic module comprises at least one group of magnets, each group of magnets comprises two magnetic sheets respectively corresponding to a feed port and a discharge port, and the reaction vessels are arranged in the reaction disk at equal intervals.

14. The system according to claim 13, wherein the full-automatic sample processing module further comprises a multi-stage cleaning component, and the multi-stage cleaning component is arranged on the magnetic reaction disk in the magnetic processing module so as to process the magnetic beads in the reaction vessels.

15. The system according to claim 14, wherein the multi-stage cleaning component comprises a waste liquid aspirating needle, the waste liquid aspirating needle is mounted on a waste liquid aspirating needle moving layer, and the waste liquid aspirating needle moving layer is driven by a waste liquid aspirating needle moving layer movement motor to move up and down such that the waste liquid aspirating needle reaches an aspiration position; the multi-stage cleaning component further comprises a liquid adding layer, the liquid adding layer is located below the waste liquid aspirating needle moving layer, the liquid adding layer is provided with a liquid adding needle, the liquid adding layer is driven by a liquid adding layer motor to move up and down, and a reaction vessel claw is arranged below the liquid adding layer; when the liquid adding layer moves down, the reaction vessel claw grips the reaction vessel in a reaction disk component, the liquid adding needle injects a cleaning liquid in air, and then a dropper moving motor drives a reaction vessel dropper to move down such that the reaction vessel is pushed out back into the reaction disk component; and the multi-stage cleaning component further comprises a guide component for guiding the liquid adding layer and the waste liquid aspirating needle moving layer to move up and down.

16. The system according to claim 15, wherein the full-automatic sample processing module further comprises a reaction vessel transmission and transport module comprising a manipulator, and the manipulator realizes transportation and loading of the reaction vessels among the sample loading module, the reaction module, the loading mechanism and the magnetic processing module.

17. The system according to claim 16, wherein a shaking disk in a sample application module, a shaking table of the reaction module and the reaction vessel transport tray of the reaction vessel loading mechanism are located at a same side of the manipulator, and the magnetic processing module is located at an upper side of the manipulator.

18. The system according to claim 16, wherein the manipulator comprises a mounting base, a first-level manipulator arm, a second-level manipulator arm, a third-level manipulator arm, a fourth-level manipulator arm, a fifth-level manipulator arm, a sixth-level manipulator arm and a vessel pickup Z-direction gripper component, and the manipulator arms of all levels are rotatable relative to each other to realize multi-angle multi-range rotation; the vessel pickup Z-direction gripper component comprises a Z-axis motion motor, a Z-axis timing belt and a motion connector, the Z-axis motion motor drives the gripper component to move up and down through the Z-axis timing belt and the motion connector, the vessel pickup Z-direction gripper component further comprises vessel pickup gripper jaws arranged in pair, the vessel pickup gripper jaws arranged in pair are respectively mounted on the vessel pickup slide rail component oppositely and connected through a vessel pickup spring, a vessel pickup curved wheel is arranged between upper ends of the two vessel pickup gripper jaws, and the vessel pickup curved wheel is rotatable when driven by a vessel pickup motor; when a wider part of the vessel pickup curved wheel rotates to between the upper ends of the vessel pickup gripper jaws, the vessel pickup gripper jaws are pushed open along the vessel pickup slide rail component, at this time, the vessel pickup gripper jaws are sleevable on an upper part of the reaction vessel, and then, the vessel pickup curved wheel continues rotating until a narrow part rotates to between the upper ends of the vessel pickup gripper jaws, thereby completing pickup; auxiliary structures comprise a Z-axis motion slide rail component and an auxiliary spring, wherein the Z-axis motion slide rail component serves as a guide component for up-and-down sliding, and the auxiliary spring functions to support a weight and reduce a motor load; and in addition, a vessel pickup limit sensor and a vessel pickup limit sensor chip are further provided to improve accuracy of vessel pickup.

19. The system according to claim 18, wherein the system further comprises an eluate input conveyor line, and the conveyor line connects the full-automatic sample processing module with a liquid chromatography apparatus and is configured to transmit a magnetic eluate from the sample processing module to the liquid chromatography apparatus.

20. The system according to claim 2, wherein the sample baskets carry sample tubes therein, and the sample tubes are configured to contain liquid samples.
